(19) United States
(12) Patent Application Publication
(10) Pub. No.: US 2014/0272847 A1
(43) Pub. Date: Sep. 18, 2014

(54) METHOD AND SYSTEM FOR INTEGRATED REWARD SYSTEM FOR EDUCATION RELATED APPLICATIONS

(71) Applicant: Edulock, Inc., Reno, NV (US)

(72) Inventors: Patrick M. Grimes, Reno, NV (US); Linda S. Grimes, Reno, NV (US); Cody M. Grimes, Reno, NV (US)

(73) Assignee: Edulock, Inc., Reno, NV (US)

(21) Appl. No.: 14/213,928

(22) Filed: Mar. 14, 2014

Related U.S. Application Data
(60) Provisional application No. 61/782,006, filed on Mar. 14, 2013.

(51) Int. Cl. G09B 19/00

(52) U.S. Cl. CPC G09B 19/00
USPC 434/236

(57) ABSTRACT

Computer implemented systems, methods and computer program products for assessing and designing customized reward-based learning sessions. These technologies involve determining factors for a student's peak academic performance, such as: 1) their preferred type of reward trigger; 2) their preferred timing of the learning objective relative to the reward; and, 3) the nature of the reward (time to use an electronic device, cash, store credit). The reward trigger is the type of event that most motivates a student to learn, such as achieving an academic milestone, demonstrating effort and improvement in lessons, and random rewards for participating in educational sessions. The timing of the learning objective relative to the reward may be measured as the time at which the user initiates operation of an electronic device, the time at which the user engages in a learning or testing exercise, or the time at which the user receives the reward.

### CROSS REFERENCE TO RELATED APPLICATIONS

The present application claims priority to and benefit from U.S. Provisional Patent Application No. 61/782,006, titled “Method and System for Integrated Reward System for Education” and filed on Mar. 14, 2013. The present application is also related to U.S. Provisional Patent Application No. 61/777,178, titled “System and Method for Instruction Based Access to Electronic Computing Devices” filed Mar. 12, 2013, U.S. Provisional Patent Application No. 61/778,988, titled “System and Method for Multi-Layered Education Based Locking of an Electronic Computing Devices” filed Mar. 13, 2013, and U.S. Provisional Patent Application No. 61/775,623, titled “System and Method for a Comprehensive Integrated Education System (CIES)” filed Mar. 10, 2013 The entire contents of the aforementioned applications are herein expressly incorporated by reference.

### FIELD OF THE INVENTION

The present invention relates to computer implemented systems and methods for optimizing a student's academic performance by customizing education sessions to maximize the reward center stimulation and/or the amount of dopamine released in the student's brain.

### BACKGROUND OF THE INVENTION

While an open debate exists about how best to educate learners, most professionals and researchers in the field recognize that “reward” plays a significant role. Many researchers have documented that the release of dopamine supports the reward concept. The brain's release of dopamine is one of the many changes that can occur when one processes a reward in exchange for a particular action (collectively referred to as Brain Reward Center Stimulation or “BRCS”). However, as it relates to a learning process, differences in the brain activities between individuals create the need to have a flexible system because students process the exchange of an action for a reward differently.

Psychologists and researchers from around the globe agree that social media, for example, is highly addictive and can be similar to drug addiction. In general, a techno-addict as an individual who is addicted to the use of electronic computing devices (e.g., television, interactive video game, Internet searching, emailing, texting, chatting, twittering, etc.). As they continue staring at the screen, their physical reaction helps their brain focus on the incoming mental stimuli because of the release of the neurotransmitter dopamine that provides them a feeling of euphoria (e.g., the reward for engaging in the activity), while also driving the craving of the activity. It would be helpful to focus on using this window of increased dopamine levels along with other neurological activity generally referred to as the reward center (BRCS), for the purpose of increasing an individual's ability to concentrate, as well as to enhance their desire, appetite, and ability to learn new information.

### SUMMARY OF THE INVENTION

Various embodiments relate to computer implemented systems, methods, and computer program products for optimizing a student's academic performance by customizing education and rewards.

In some embodiments, a reward-based improvement (and/or incentive) system performs the following methods. It determines a learning state related to a reward for the user from one or more learning states, a learning activity status related to the reward for the user from one or more learning activity statuses, and a reward category related to the reward for the user from one or more reward categories. As a result, it grants a reward to the user based on the determined learning state, the determined learning activity status, and the determined reward category.

In some embodiments, a reward-based improvement (and/or incentive) system comprises a first determination unit configured to determine a learning state for providing the user with a desirable level of learning motivation, where the learning state indicates whether the user is learning, making progress in learning, or achieving a milestone in learning; a second determination unit configured to determine a learning activity status for providing the user with a desirable level of learning motivation, where the learning activity status indicates where the user stands with respect to a course of a learning activity; a third determination unit configured to determine a reward category for providing the user with a desirable level of learning motivation; and a customization unit configured to grant a reward to the user based on the determined learning state, the determined learning activity status, and the determined reward category.

In some embodiments, a reward-based improvement system (and/or incentive) performs the following methods. It detects a current learning state and a current learning activity status of the user, where the learning state indicates whether the user is learning, making progress in learning, or achieving a milestone in learning, and the learning activity status indicates where the user stands with respect to a course of a learning activity. Next, it determines whether the detected learning state is equal to a predetermined learning state and whether the detected learning activity status is equal to a predetermined learning activity status. As a result, when the determination result is positive, granting a reward in a predetermined reward category to the user.

### BRIEF DESCRIPTION OF THE DRAWINGS

The above and other features, aspects, and advantages of the present invention will become better understood with regard to the following description, appended claims, and accompanying drawings where:

FIG. 1 is a diagram illustrating an example environment in which a reward-based learning system provides each student with a customized and motivated learning experience.

FIG. 2 is a diagram illustrating a user interface of the user's electronic device that enables a user to participate in reward content.

FIG. 3A is a diagram illustrating examples of reward triggers or reward timing in terms of learning states.

FIG. 3B is diagram illustrating examples of random triggers based on a user's location, characteristics, and/or activity they engaged in.

FIG. 3C is a matrix of a random trigger that is based on a step in a series of events a user may be engaged in.

FIG. 3D is a matrix of various embodiments describing how an entire group of students, peers or employees could work for a random reward

FIG. 4 is a diagram illustrating example instances of reward timing in terms of learning activity statuses.

FIG. 5 is a diagram illustrating examples of rewards.

FIG. 6 is a block diagram illustrating example components of the reward-based learning system.

FIG. 7 is a diagram illustrating an assessment matrix.

FIG. 8 is a diagram illustrating an example matrix for methods of assessment for three levels of difficulty in a math tutorial to identify the point at which a student can be tested at the next higher level.

FIG. 9 is a diagram illustrating an example matrix for methods of assessment for three levels of difficulty in Pattern Recognition.

FIG. 10 is a diagram illustrating example levels of difficulty for various Reading tests.

FIG. 11A is a user interface diagram illustrating an example emergency override feature.

FIG. 11B is a user interface diagram illustrating an example third-party override feature.

FIG. 12 is a flowchart illustrating an example process performed by the reward-based learning system to set up profiles for users and provide users with optimal reward-based learning experiences based on the profiles.

FIG. 13 is a flowchart illustrating an example process performed by the reward-based learning system to manage a user's optimal reward-based learning experience.

FIG. 14 is a diagram illustrating example components of an adaptive learning process.

FIG. 15 contains a high-level block diagram showing an example architecture of a computer.

### DETAILED DESCRIPTION

As used herein, the term “User” refers to the person (e.g., student) who is attempting to gain access to their electronic computing device, such as a cellular phone, tablet, laptop, personal computer, wearable device, television, and game console, or other rewards, and may be required to complete one or more assessment tests or complete historical analysis interviews to determine their optimal learning conditions.

As used herein, the term “Third Party” refers to the entity who plays a supervising role in a user's learning experiences. For example, a third party may be a parent, an employer, a coach, etc.

As used herein, the term “Software” refers to computer program instructions adapted for execution by a hardware element, such as a processor, wherein the instruction comprises commands that when executed cause the processor to perform a corresponding set of commands. The software may be written or coded using a programming language and stored using any type of non-transitory computer-readable media or machine-readable media well known in the art. Examples of software in the present invention comprise any software components, programs, applications, computer programs, application programs, system programs, machine programs, and operating system software. For purposes of this invention, instructional material and instructional software is the same as education material and education software in so far as an instruction can be to complete a question among other actions like move an arm or run a specific distance.

As used herein, the term “Component” refers to a portion of a computer program or software or computer hardware that carries out a specific function (e.g., testing module, etc.) and may be used alone or combined with others.

Researchers have found that the more motivated and interested one becomes with an activity, the more dopamine (among other events in the BRCS) is released and the better they remember. The reward center helps the brain remember and repeat activities that were reinforced through positive outcomes—whether it is finding and returning to a location where good things happened or just remembering interesting information.

Researchers and scientists are frequently publishing reports that refer to the new levels of addiction to electronic entertainment. For example, one study of more than 1,000 students from 10 countries and 12 universities concluded that the majority were not able to voluntarily forego their electronic connections for a mere 24 hours. In particular, the study found that these college students admitted to being “addicted” to modern technology, such as mobile phones, laptops and television as well as social networking applications offered by Facebook, Inc. and Twitter, Inc.

Functional magnetic resonance imaging (fMRI) was used in another study to visualize which parts of the brain were engaged during certain aspects of social media. The overall conclusions were that the use of social media, and in particular expressing one's owns opinion, positively triggers dopamine reward pathways. The researchers even determined that many of the subjects would prefer reporting their own experiences to receiving a small monetary reward.

Similar indications were noted in certain video gaming, which introduce high levels of “randomness” in reward granting as an intentional means of forming an addiction. The idea dates back decades, and it is used to create a compulsion loop that keeps the player engaging in the activity. The technique is referred to as the variable ratio of reinforcement or operant conditioning. Operant conditioning is formally defined as the use of consequences to modify the occurrence and form of behavior. The model involves the operations of positive reinforcement, negative reinforcement, extinction, response cost punishment, and punishment.

In the positive reinforcement, a person who emits a desired behavior (e.g., raising her hand and waiting to be called on) receives something good—a positive consequence (referred to as positive reinforcement). This may be a smile or praise or a piece of candy. The result of the reinforcement is that the behavior is strengthened, that is, its likelihood of subsequent occurrence increases. This represents a positive form of control.

However, various reinforcement schedules have an effect on educational outcomes by affecting the likelihood of a particular response. A continuous reinforcement schedule, wherein every occurrence of a desired operant response is followed by reinforcement is desirable when operant conditioning is first taking place. However, once the desired response occurs on a regular basis, it can be maintained by only occasional or intermittent (or a form of randomness) reinforcement.

According to traditional behavior science practices there are four possible intermittent reinforcement schedules: fixed ratio, fixed interval, variable ratio, and variable interval. In an educational setting (as in most settings), the two variable schedules best maintain the desired behavior, primarily because of their unpredictability. Hence, the element of randomness is a proven reward to elicit learning notwithstanding the benefits of the fixed ratio and interval approaches.

According to a number of studies, the motivations for students to learn and the ingredients for teachers to create environments where students want (or are motivated) to learn and retain information are complex. However, a great number of the studies suggest that students who are rewarded for a particular learning task or series of learning tasks can excel (relative to their peers who are not rewarded). Unfortunately, what one student considers a reward may not be considered a reward by another. Thus, even when students are identified as those who are motivated to learn by a reward, the selection of an appropriate reward is essential for the learning program to be a success. The embodiments of this invention are not limited to students and teachers rather it is only an example. Other instances include a variety of “learning environments” such as employers and employees, parents and children, coaches and players, and doctors and patients. Further, the “learning environments” are not limited to traditional academic subjects and may include work safety, chores around the house, team plays, and medical rehabilitation.

FIG. 1 is a diagram illustrating an example environment in which a reward-based learning system provides each student with a customized and motivated learning experience.

The reward-based learning system links together a reward system 150 and a learning and education system 170 to motivate and enhance the learning experience of users through the use of electronic computing devices and other means.

In some embodiments, the reward-based learning system 140 comprises a client-server architecture where the server portion stands alone or runs on a cloud-computing platform, and clients communicate with servers via networks.

The reward-based learning system 140 or the server portion thereof may reside on the cloud-computing platform 130, making its functions readily accessible by other systems that are connected to the cloud-computing platform 130, which may include the user device 100, the monitor device 120, the network provider system 160, the learning and education system 170, and the reward system 150.

In some embodiments, the reward-based learning system 140 is entirely integrated into a system or a device, such as a user's electronic computing device or a network service provider system. In addition, the system may be integrated into or in communication with the reward system 150 and the learning and education system 170.

In some embodiments, the reward-based learning system 140, or at least the server portion, may stand alone and communicate with network provider system 160, the learning and education system 170 and the reward system 150 through their application program interfaces (APIs) to simplify change and maintenance, for example. In some embodiments, the reward-based learning system 140, the server portion, or the client portion may be integrated into some of these other systems to reduce network traffic, for example.

The network provider system 160 comprise commercial entities providing services to wireless and digital electronic computing devices, such as Vodaphone Group Plc, AT&T Inc., Verizon Communications Inc., etc. The services that would be included would include all communications such as radio communications and satellite communications along with 2G to 4G Wi-Fi, cable and combinations as well. They may control the network connectivity and data usage of electronic computing devices, and their products and services may incorporate the reward-based learning system 140. For example, when a parent signs up for a wireless plan, he may specify performance objectives, skills to be improved, and rewards to be earned for his child as part of a service agreement, and the wireless company as a network provider system 160 may utilize the reward-based learning system 140 to communicate with learning and education systems 270 and reward systems 250, for examples, and streamline the learning-reward process for the child.

The learning and education system 170 comprises systems and methods for evaluating performance statistics, providing testing and education materials, analyzing learning patterns, and so on. In terms of providing testing materials, the learning and education system 170 may maintain various formats—test questions taken before a reward is given—as well as goals or other evaluations. The testing subject matter (e.g., math, history, missed test questions, etc.) and format (e.g., multiple choice, true/false, pattern recognition, etc.) may be selected by the user, the monitor, and so on. As one example, on a particular day, the student chooses the level of difficulty of the questions, the subject matter, etc. depending upon their mood, their time availability, their level of fatigue, a pending deadline (e.g., SAT test date), etc. As another example, the test questions may be chosen by a monitor (e.g., parent or the system) and depend upon: the user's performance on a test or goal administered by another (e.g., SAT grades); or a user's performance over a period of time in a particular area (e.g., semester grade in a class) and/or as a whole (e.g., semester grade average for all classes). The test questions and the user's answers may take multiple formats of electronic communication: SMS texting; regular text document on a webpage or downloaded in write-over formats (e.g., Word, write-over PDF, etc.); still images; video; audio; etc.

In addition, the test materials may comprise the user accomplishing more than one task concurrently that are related in topic, such as questions and then a practical exercise. As one example, a test may involve a series of questions about how to operate safely a particular home appliance. As another example, an employer may require new or periodic training for his employees for operating equipment, such as a forklift or other machinery. The test taker must answer the questions correctly and operate the appliance safely and correctly before receiving a reward.

In terms of providing education tools, which may be presented to a user before or after the presentation of test materials, the learning and education system 170 may compile materials on various topics from subjects taught and tested in school, such as English and history, to those of general interest, such as journalism and entertainment. It may further classify these materials into different difficulty levels and formats. For each user, the selection of difficulty level and format may depend on the user's performance statistics, learning styles, etc. For example, for a student in the history class who has received a high score, the education materials may cover advanced subject matter with complex details, while for a student who has shown no interest in history, the education materials may cover basic topics in an easy-to-absorb format. For instance, an “adaptive learning” element can be applied where as the student answers questions correctly, the questions (and or question types) get more challenging. Alternatively, as the student answers questions incorrectly, the questions (and or questions types) get less difficult. The “adaptive learning” can incorporate additional features such as those described elsewhere in this document pertaining to facial recognition and optical scan analyses. In these instances the electronic computing device used by the end user serves an additional purpose by measuring bio-physical aspects of the end user to enhance their learning experience. In other words, some end users may form disgruntled looks on their faces or roll their eyes when they are frustrated with the learning objective. It is an intent of this invention, among other things, to intercept the learning experience before the end user answers a question incorrectly by changing the value of reward (and thereby increasing motivation) or by decreasing level of difficulty. The same bio-physical observations can be made with reward selection and assignment and therefore the same interception strategy can be followed. Bio-physical observations include sound level detection, heart-rate, blood pressure, sleeping pattern, etc. Educational institutions, specialized learning agencies, and/or supervisors may work together towards the compilation of necessary materials based on first-hand teaching experiences or additional research.

In terms of analyzing learning patterns, the learning and education system 170 may analyze how a user goes through existing learning processes and predict effective learning processes for the user based on trends and patterns detected in the analysis. As used herein, “pattern recognition learning” refers to the ability to learn new information by a simple examination of new material. An example might be a student who memorizes the multiplication table but does not understand the relationships of the numbers. Specifically, a student might know that 7 multiplied by 6 is 42, but they may not understand why. In addition, “cognitive learning” refers to the ability to learn new information by an analysis and detailed examination of new material. An example might be a student who doesn't memorize the multiplication table but understands the relationships of numbers. Specifically, a student might not know 6 multiplied by 7 is 42, but he knows that if you add (7+7+7+7+7+7) or (6+6+6+6+6+6+6), a correct answer will be achieved.

As one example of analysis, the learning and education system 170 may determine if a particular student's learning is enhanced when a new topic is introduced through cognitive skills or pattern recognition skills: whether the format of the new content is visual, audio or interactive; whether a student performs better when answering multiple choice or true false questions; and whether the student does just as well on the final 10 questions as the first 10 questions. As another example of analysis, the learning and education system 170 may determine a user's frequency in test taking (e.g., date and time) and track the test timing to determine student's optimal performance or poor performance due to specific factors.

The reward system 150 comprises various forms, such as: the unblocking of a user's desired electronic device, and/or functions on the device (e.g., gaming applications, Internet access, texting, video chat); other activity not related to the use of electronic computing devices; and/or giving the user in/tangible item(s). The user may select the type of the reward, or it may be automatically designated based on the type of testing or by the supervisor. Other examples of forms of rewards comprise cash, a retailer redemption debit card, and a coupon redeemable online or at store. Further still, in an employment setting, the employee may be given a monetary bonus, extra holiday or vacation time or discounts on the employer's products and services as a reward.

Specifically, access to an electronic computing device may be controlled by different methods/entities, comprising: 1) software modules on electronic computing devices, as discussed in further detail below, which may block the use of the device until academic requirements (e.g., quiz blocking access to SMS) are satisfied; 2) network providers, as discussed in further detail below, who may block access to a user's account/device until certain performance objectives are met; 3) education module providers, as discussed in further detail below, which may block access to a student's device until grades are achieved, and 4) supervisors owning the device utilized by the user, such as employer-owned personal digital assistants for employee use.

A number of security options exist to block and unblock electronic transmissions from a computing device in order to, for example, protect the device from being used inappropriately. Methods known by someone skilled in the art comprise those for handling the following scenarios: (1) use by unauthorized person; (2) use at an unsafe time; (3) use to explore “inappropriate” applications; and (4) use to abuse “appropriate” applications.

In some embodiments, the cloud-computing platform 130 represents a family of services hosted on one isolated server, multiple isolated servers, or on distributed servers that virtually appear to clients to be a single server. It is isolated or divided onto isolated different servers to facilitate the isolation, organization, and management of diverse families of functions that may be accessed by some authorized parties but not others. As one example, the services that may be utilized by the learning and education system 170 may be hosted on one server. As another example, the services for submitting new education and testing materials by the monitor device 220 and the services for dispersing such materials to the user device 100 may be hosted on separate servers. In order to properly function, these separate servers may need to privately share information with each other via messaging and API calls, common interfacing, and messaging techniques known to those skilled in the art.

A user device 100 is a user's electronic computing device with web browser capabilities configured to communicate with the reward-based learning system 140 via the cloud-computing platform 130 or otherwise through networks, which comprises any public network, such as the Internet or World Wide Web or any public or private network as may be developed in the future. It is the means by which the user participates in the reward-based learning system 240. It may receive and respond to educational/testing modules provided by the learning and education system 170, reward data provided by the reward system 150, and other modules and data loaded into its memory. The monitor device 120 is a monitor's electronic computing device with web browser capabilities configured to communicate with the user device 100, or with the reward-based learning system 140, through the cloud-computing platform 130 or otherwise via networks. The user device 100 and monitor device 220 may connect to the network via a variety of methods, such as a phone modem, wireless (cellular, satellite, microwave, infrared, radio, etc.) network, Local Area Network (LAN), Wide Area Network (WAN), or any such means as necessary to communicate to a server computer connected directly or indirectly to the network.

In some embodiments, the user device 100 and the monitor device 120 are one in the same electronic computing device with the client portion of the reward-based learning system 140 installed thereon. The client portion enables the monitor to select and/or review the activity of the user in practicing educational modules. The monitor's access to the educational modules may be protected by a security feature (e.g., login credentials) to permit the monitor to select which educational modules for the user to practice and the approved solutions (e.g., answers) for the modules.

In some embodiments, the user device 100 has the client portion or the entirety of the reward-based learning system 140 installed to enable the user to practice test/educational modules and/or to enable the user to receive rewards upon a satisfactory practice. As one example, the client portion may have the device blocked with direct control or through a network service provider. Upon a successful completion of the modules, the client portion then permits the blocking of the entire user device 100, and/or particular features (e.g., Internet access or texting capabilities) of the user device 100. As another example, if the user has elected to receive cash and/or deposits to their credit or debit cards from the monitor, the user device 100 may communicate successful completion of the educational module directly with the monitor device 220 or through the reward-based learning system 140, which may then notify the monitor device 220 of the reward due. The cash transactions may be accomplished by using PayPal or Amazon Coins, for example.

Some examples are provided below to illustrate the various different ways the reward-based learning system may interact with the other systems in the environment. In one example, Kaplan, a popular standardized test provider, would log into the reward-based learning system 140 to enter their user ID and password and upload their target education content such as SAT or GMAT vocabulary words. Apple, Starbucks, Target, and PayPal would similarly enter their user ID, password and reward claim. Together, Kaplan and the retail providers have created a contest to see which student can answer correctly 25 vocabulary words the quickest from a standardized test format. Furthermore, the students can pick a single retail reward from one of the retail providers or pick from a combination of rewards from the retail providers. For example, one student may choose to claim a single reward from Target, which is a $20 gift card. A second student may choose to claim a combination of rewards from Apple and Starbucks, which are a $10 gift card to the Apple Store and a $10 gift card to Starbucks. A third student may choose to claim a single reward from PayPal™, which is a direct payment of $25 to the student's debit card. The students can enter the said contest through the reward-based learning system 140 from any location. The reward-based learning system 140 may determine which student has won the contest and processes the information provided. In this case, the second student may win the contest and gets a $10 gift card to Starbucks and Apple. When the second student chooses to use the rewards, the reward-based learning system 140 may connect with the Starbucks and Apple Store database and provide an electronic coupon code to the student through an electronic message, such as a bar code. Once the second student redeems the reward, the coupon redeemed may be matched against the coupon issued thereby ensuring that the coupon can only be used once. Alternatively, when the reward-based learning system 140 receives the indication that the student has achieved a reward, it can instantaneously give credit to the second student's Starbucks Gold Card or Apple ID account, allowing the student to make a purchase directly.

In another example, the education content provider, such as Kaplan and the retail provider Starbucks, creates a contest for a group of high school students. Kaplan would log into the reward-based learning system to enter their user ID and password and upload their target education content, such as SAT or GMAT vocabulary words. Starbucks would similarly enter their user ID, password, menu, and reward claim. Kaplan and Starbucks may create a contest to see which student can answer correctly 25 vocabulary words the quickest from a standardized test format. Using GPS signals, the students are identified while in a Starbucks store and join the contest through their electronic devices. Each of the students may be in the same location or different locations. Students can be groups of students in class rooms or any group, such as a church group. In lieu of the GPS coordinates, the activity of the contest could include any type of membership program that could allow students or groups to enroll and compete in the contest from remote locations through the reward-based learning system 140. Each student is provided the questions at the same time from the reward-based learning system 140, and each answer is analyzed. In one case, the reward-based learning system 140 determines that a student won the contest when the answers and speed upon which student submitted answers is confirmed by the Kaplan. Alternatively, the questions could be provided throughout the day and the winner would then be decided at the end of the day (or another period of time, if so desired). If the winning student chooses a particular reward and to redeem the reward, the reward-based learning system 140 may connect with the Starbucks database and provide an electronic coupon code to the student through an electronic message, such as a bar code. Once the student redeems the reward, the coupon redeemed is matched against the coupon issued thereby ensuring that the coupon can only be used once. Alternatively, when the reward-based learning system 140 receives the indication that the student has achieved a reward, the rewards cloud can instantaneously give credit to the student's Starbucks Gold Card, allowing the student to make a purchase directly.

In other examples, random rewards could be generated for those who participate in the reward contest. In a random reward scenario, any participant, including the winner of a contest, could be rewarded. Further still, the randomness could be linked into a “progressive” reward system that allows users to participate in various, interlinked, reward programs so that a high school student working through SAT content, or an elementary school student working through multiplication tables, or an employee working through safety training, or a rehabilitation patient working on exercises are all optionally linked together (in a progressive manner) or in subgroups competing for the same random prize or the same random value that can be applied to different prize categories. For example, in one case, all of the different individuals could compete for a credit to the Apple Store or cash. However, not all of the different individuals would select that same reward if a coupon was provided from contributing retailers like Barnes & Noble, Starbucks, Target, Macy's etc. The current invention is not limited to the examples provided rather the examples are intended to demonstrate the types of embodiments that are included in the scope of the invention.

Yet another example is presented where the reward is access to a user's electronic device. FIG. 2 is a diagram illustrating a user interface of the user's electronic device. In this example, the phone is turned on, and the normal security feature is displayed in 205. Next, the question(s)/instructions already stored on the user's electronic device are displayed or the question(s)/instructions may be downloaded from a remote education website before being displayed in 210. Upon selecting the questions, the user may see that the contest is for a $10 Starbucks gift card, and the user chooses to play in 225. After selecting the play icon, the user begins the contest by answering the contest questions which can be, but are not limited to, standardized test questions, trivia, basic math, etc. in 235. Once the user has finished the contest in 245, the electronic device (e.g., smart phone) will allow the user to have open access to the device in 250, acting as the unlock feature to access the device. Alternatively, the contest can act as a side competition, and once the user has finished the competition, the user will be directed back to the mobile app question(s) landing page in 245, whereby the user will have to answer additional questions to unlock the device. The reward process can be enhanced with combined with an “adaptive learning” component to enrich the learning state while excited about the reward anticipation.

Various embodiments relate to the reward-based learning system and related methods and computer program products for optimizing a student's academic performance by customizing education sessions to maximize the amount of dopamine and other stimulants released into the student's central nervous system and brain in relation to a reward. The amount of dopamine and other stimulants released directly relates to a student's response to a reward offered as part of participating in the learning/testing session, in terms of the following three motivating factors in particular: 1) reward timing in terms of learning state (reward-trigger event); 2) reward timing in terms of learning activity status (student action with respect to education content); and 3) the reward category (nature of reward). Each of the three motivating factors is first discussed in detail below.

### Reward Timing in Terms of Learning State (Reward-Triggering Event)

A student's response to a particular reward mechanism with a release of dopamine (thereby creating the potential for an enriched learning process) can vary from student to student. For example, is the student's dopamine release triggered when they are confronted with the opportunity for a reward or when they have received the reward? In some cases, it might be something in between or a combination. Further, within a single student, the BRCS can change over time as the student becomes more familiar with a routine, for instance. The reward trigger is the type of event that most motivates a student to learn, such as achieving an academic milestone, demonstrating effort and improvement in lessons, and random rewards for participating in educational sessions and other instructional types of modules and “learning environments”.

The opportunity for optimizing learning requires a flexible type of reward trigger that can be provided to individualized learners. FIG. 3A is a diagram illustrating examples of reward triggers or reward timing in terms of learning states. The first reward trigger relates to achieving specific milestones. Specific milestones triggers enable a student to earn a reward by achieving a specific goal over a defined period of time. Examples include specific semester grades (such as a 3.5 grade point average), particular tests or quizzes in one or a number of subjects (such as an 85% on an English test) and pass/fail tests (such as passing grade on a driver's education test for a learners permit or the occupational safety and health test on a safety aspect in the work place). In each of these cases, students are motivated to achieving specific and measurable education objectives that trigger rewards once the specific objective is achieved.

The second reward trigger in FIG. 3A relates to demonstrating effort. Demonstrating effort triggers enable a student to be eligible for a potential reward. Examples include showing progress for a given set of questions, establishing a pattern of attempting problems, and working on targeted areas (in each of these examples, accuracy is optional; in other words, the trigger can be demonstrating a reasonable effort). In each of the cases, students are motivated to participate in education content because it triggers rewards.

The third reward trigger in FIG. 3A relates to random assignment. Random assignment triggers enable a student to be eligible for rewards at unspecified times. The timing of such triggers may be related to measurable instances, such as turning electronic computing devices on and off, and idle time during a given login to an education session. In each of these cases, students are motivated to participate in the educational session with the understanding that the trigger for reward may be an act of random selection under the principles of the compulsion loop and operant learning rewards.

The trigger of random assignment is one of particular interest for a student interested in self-study. In other words, a user who is not driven by a parent or a teacher, employer, rehab specialist, doctor, etc., could find this particular trigger of unique relevance. The relevance being that at any given time as long as they are engaged in learning, they could be entitled to a reward.

FIG. 3B is diagram illustrating examples of random triggers based on a user's location, characteristics, and/or activity they engaged in. In the first case, the random reward could be location-based, where, for example, if a student were walking by a retail sponsor, they could be informed of a particular reward, such as those disclosed in FIG. 5. In the location-based award, a set of GPS coordinates would be activated such that any electronic device traveling within such coordinates triggers a reward, such as drop into Walmart for a discount or a free soda.

On the other hand, a student who has already accumulated a reward, such as a block of time on a social media site like the Facebook® website, could be notified when they are located within a specific boundary of GPS coordinates relative to a retailer, such as Target. They would then be asked if they would like to trade their reward for a coupon for an immediate purchase at Target.

In a second case, the reward could be status-based, where, for example, an employee who has completed all of their training related to emergency evacuation from a cloud-based service, such as Knoodle, Inc., could become eligible with all the other employees who also completed the same training or comparable training. Therefore, on a particular day, the company could identify an employee through their electronic device and inform them of a particular reward, such as those disclosed in FIG. 5. Further, as it is an employee, the reward could also be something employee or department specific, such as a bonus or extra vacation time.

In yet another case, the reward could be activity-based, where, for example, a student could be engaged in a particular learning event, such as studying for a drivers permit. Therefore, at a random time when a student is logged onto a study module, he could be granted a reward, such as those disclosed on FIG. 5.

Some students may prefer only one type of the above reward triggers whereas others may prefer a combination. For example, one student may prefer to have education material he considers easier connected to achieving a milestone whereas he may also prefer to have harder education material connected to a random reward. In some instances, an assessment test may be provided to the student to determine what is best for him.

In yet another case, there can be a progressive lottery type of syndicate. A group of students may join into a particular type of learning or sign up for a particular type of reward that is provided by a corporate or retail sponsor. For example, a group of students studying similar content for a test prep, such as the SAT, could all compete for a random reward. Specifically, the commonalty is the SAT content, and they are each competing for a randomly generated reward. Similarly, a group of employees within a large organization with multiple locations around the world could sign up for a specific reward, such as additional vacation time, a gift certificate for coffee, etc., regardless of their job training content. Specifically, the commonalty is not the learning content; it is the specific reward.

FIG. 3C is a diagram illustrating examples of a purely random progressive system whereby an individual (or group) would forgo their anticipated or scheduled reward for the opportunity for a bigger reward. The bigger reward would be based on the number of other individuals (or groups) doing the same. For example, in one case, a student may have already earned a reward, such as coffee credit to a Starbucks for completing her geometry module. Rather than “cash in” the credit, the student would alternatively forgo the coffee credit in exchange for a chance to be awarded a larger credit, such as ten free coffees. As discussed earlier, the trigger could be every time she turns the power on to her phone. It could be when she is logged on, and, in such a case, the award could be forgoing a download of Angry Birds® that she earned when she completed her supplemental math module in exchange for a twenty-five dollar gift certificate to iTunes store. In addition, the trigger could be when she powers off the device, and, in such case, the award could be forgoing a gift certificate for a 20% discount from Macy's that she earned by maintaining a cumulative GPA of 3.5 in exchange for a an opportunity to win a fifty dollar coupon.

FIG. 3D is a diagram illustrating examples describing how an entire group of students, peers or employees could work for a random reward. In the first example, a group of students from a particular English class in a school for freshmen could compete against a particular English class for freshman from another school. It could also be different class levels from the same school as well. The winning class would be defined as one who completes their homework assignment first, and their reward could be access to rewards, such as Angry Birds®, SMS or the like as illustrated in FIG. 5. In the second example, a group of employees from a particular department, such as finance, could be competing against the sales department. The winning class would be determined based on the efforts of the group. Specifically, perhaps the group that attempts the most questions without going lower than 75% accurate over a specific period of time would receive the reward. The reward could be the winning department gets to leave work early on the Friday before a Holiday weekend. In the third example, a group could be rewarded on a purely random basis every time they logged onto a device. In this instance, it could be every individual who is participating in a standardized preparation test, such as those for SAT offered by Kaplan, Inc. In this instance, the reward could be any combination of rewards from FIG. 5.

The progressive link and the GPS could be combined thereby creating a bigger reward potential. For example, perhaps the students contribute a portion or all of their earned rewards into the mix with a larger group in exchange for a chance at a larger reward. Specifically, students who have already earned a reward, such as a free download from the Apple Store, might surrender it in exchange for a chance at an iPhone 5. Further, the opportunity to win the iPhone 5 might be linked directly to their GPS when they enter an Apple Store.

Additional rewards triggers may include: check-in at certain places, such as school; third-party school reporting; extracurricular conditions/goals; completion of chores; school attendance; homework completion; direct teacher third party reporting; API calls to teacher server for tracking grades; API calls to school hosting server; accomplishing specified blocks of educational content; exposure to certain blocks/time periods of learning content (video, audio, eBook); incentives for study groups/studying content together with device users; group contests; educational content; extracurriculars—outside contests that specify device user(s) as meeting, criteria, and allot those rewards to qualifying user id's for redemption.

Reward Timing in Terms of Learning Activity Status (Student Action with Respect to Education Content)

Separate from the type of reward trigger, the student may find that their appetite for learning varies based on the timing at which the reward is delivered to them relative to the education content. Determining precisely when the student's BRCS (and therefore their learning potential) is maximized plays a crucial role in when he may learn most efficiently. In the present invention, the timing of the learning objective relative to the reward is measured as the time at which the user initiates operation of an electronic computing device (e.g., tablet); the time at which the user engages in a learning or testing exercise; or the time at which the user receives the reward.

FIG. 4 is a diagram illustrating example instances of reward timing in terms of learning activity statuses. In the first scenario (A), the student initiates the use of an electronic device, such as a cell phone. Despite not having access to any of the non-emergency features initially, the student may have a dopamine release (BRCS) because he expects to be rewarded with the use of the Facebook® application at the end of his learning experience.

In the second scenario (B), the student begins to answer questions on his electronic device, such as a laptop. Despite not having access to any of the non-emergency features initially, the student may have a dopamine release (BRCS) while he is answering incremental questions. Further, the release of dopamine (BRCS) may be occurring as he is correctly answering each individual question of a larger set.

In the third scenario (C), the student has completed the targeted education content on his electronic device, such as game control. In this instance, the student is provided an indication that he has completed the objective, and the reward is available, and this may initiate a dopamine release (BRCS).

In the fourth scenario (D), the student has gained access to his targeted reward like a sitcom on his electronic device, such as a television. In this instance, the student is beginning to watch his desired sitcom, and this may initiate the dopamine release (BRCS) as he is in the process of physically enjoying the reward.

Some students may prefer only one type of the above whereas others may prefer a combination. In some instances, an assessment test may be provided to the student to determine what is best for him.

### Reward Category (Nature of Reward)

Despite the fact that a primary motivation for the student to complete the targeted education learning is to earn access to their electronic device to get a “fix” on their addiction, providing further rewards may be required to maximize the learning experience. For instance, in some cases, access to the electronic computing device might create a minimalistic approach to the education objectives. In other words, the student may be limited in his desire to complete any work beyond the minimum content that provides him the access time desired for his electronic device because of the electronic device's addictive characteristics. Various embodiments in the present application show that rewards may comprise time to use an electronic computing device, monetary cash, bitcoins, bank account deposits, debit cards, loaded gift cards, store credit, coupons or discounts. Control of the user's electronic computing device may be by a third party, such as a web-based service and/or the network service provider, and may further comprise remotely un/blocking the device or specific functions of the device (e.g., Internet).

By way of example, a student might determine that he requires 90 minutes a day of access to his electronic devices to maintain his socialization requirements for his “textaholic” tendencies. To this end, the student may perform only the minimum amount of education content to access 90 minutes. However, by complimenting, or even replacing in some cases, the electronic device access with another layer of reward mechanism, the learning process has a much higher probability of success for enhanced learning. Further, the different type of rewards can help customize the reward experience.

FIG. 5 is a diagram illustrating examples of rewards. In the first category, the student is provided access to one of the standard functions on his cell phone, such as text messaging. Other standard options are readily available, such as GPS, calendar, etc., and could be provided individually or in combination.

In the second category, the student is provided access to one of the applications or non-standard functions, such as the game Angry Birds on his tablet. One familiar with the art would know applications like Angry Birds that are downloaded to the electronic device are not critical to the primary functions of the tablet. Other non-standard options are readily available through the AP stores, such as Google Play and Apple Store, and could be provided individually or in combination.

In the third category, the student is provided a designated credit to purchase items online, such as from Amazon through a standard credit instrument such as a prepaid debit card or an “electronic credit”, such as Starbucks Card eGift. Other options are readily available, such as Walmart.com, the Apple Store, etc., and could be provided individually or in combination.

In the fourth category, the student is provided a designated credit to purchase items at a retail store, such as from a Starbucks store through a standard credit instrument such as a prepaid debit card or an “electronic credit”. Electronic credits are growing more popular and include the ability to use a code system on an electronic device to be scanned. Other options are readily available from various merchants, such as Target Corporation, GAP, Inc., etc., and could be provided individually or in combination.

In the fifth category, the student is provided with a designated coupon for discounts on items online, such as from www.barnesandnoble.com, through a standard credit instrument, such as a prepaid debit card or an “electronic credit”. Other options are readily available from various online merchants, such as the Android AP Store, eBay.com, etc., and could be provided individually or in combination.

In the sixth category, the student is provided a designated coupon for discount on items at a retail store, such as from Macy's, Inc. through a standard credit instrument such as a prepaid debit card or an “electronic credit”. Electronic credits are growing more popular and include the ability to use a code system on an electronic device to be scanned. Other options are readily available from various merchants, such as Abercrombie & Fitch Co., Tiffany & Co., etc., and could be provided individually or in combination.

In the seventh category, the student is provided a designated debit for a fixed amount to a standard bank account at a bank, such as Bank of America, N.A., through a standard credit instrument such as a prepaid debit card or an “electronic credit”. Electronic credits are growing more popular and include the ability to use a code system on an electronic device to be scanned. Other options are readily available, such as Wells Fargo, Citibank, etc., and could be provided individually or in combination.

In the eighth category, the student is provided a designated debit for a fixed amount to a standard account at an online payment cash transfer center, such as though the PayPal® service or Amazon Coins to purchase items such as those already mentioned. Other options are readily available and could be provided individually or in combination.

In the ninth category, the student is provided a designation of effort or accomplishment, such as an electronic badge. Badges demonstrate an evolution of change and improvement and can include posting to social messaging sites, such as the Facebook® website. Designations provide for “likes” which is, in part, what drive social media outlets like Instagram. The ability to post the reward as a designation includes the ability to create many competitions within specific groups. For example, a highly motivated group of students for a prep class like the SAT can create competitions as students complete different levels of accomplishment, such as time spent, accuracy, time per correct answer, etc.

In the tenth category, the student is provided a credit or full payment for their monthly service bill from their cell phone and/or cable carrier. The services that would be included would be 2G to 4G, Wi-Fi, cable and combinations as well.

Additional rewards types include: Cumulative allowance credit, activated in portions for continued performance of criteria rules; Periodic allowance credit, activated periodically for fulfilling minimum conditions; Third Party bestowal; and third party can immediately bestow through portal for arbitrary things (mowing lawn, polite behavior, etc.).

They also may include a reward of gamesmanship. Students can “double down” (or specified extra reward) with rewards by completing extra credit education content; students can risk x to gain y by attempting harder extra credit questions, which would prove an A+ level of excellence in learning the material. A special Third Party at any “real life” gamesmanship can be designated to be the “decider” of an award or contest, such as a sprint or a talent show, and immediately bestow the award to the user via their user id through a portal or directly through an application loaded on each device. They can also participate in a progressive lottery type of engagement where they are subject to random rewards linked to greater risk of loss.

FIG. 6 is a block diagram illustrating example components of the reward-based learning system 140. The reward-based learning system 140 comprises an assessment component 602, a user component 606, an enforcement component 608, an update component 604, a reward component 610 and an education component 612. The assessment component 602 and the update component 604 maintain one or more customized, reward-based learning profiles for each user, and the user component 606 and the enforcement component 608, together with the reward component 610 and the education component 612, use the profiles to help each student achieve optimal reward-based learning experiences.

In some embodiments, the reward component 610 interacts with one or more external reward systems, such as retailers, mobile device manufacturers and network service providers, to provide rewards to the users. It may allow a reward system to set up an account and specify its offerings and associated conditions. In one example, the reward component 610 allows a retailer to identify itself through a traditional login and enter rewards promotional information, rewards claim criteria (which may include, but is not limited to, GPA, passing percentage, test scores, local trivia questions, and so on), and any other information relevant to the promotion, redemption requirements, and so on. The reward component 610 processes the information entered by the retailer and makes the rewards offered by the retailer available to the users. In addition, the reward component 610 may allow a retailer to sign up for a location-based reward feature. In that case, it may enable a reward system to directly receive a user's GPS coordinates to determine whether the user is near the reward system's physical location, or it may track a user's GPS coordinates and notify a reward system when the user is near the reward system's physical location.

In some embodiments, the reward component 610 allows a user to accumulate earned rewards and manage the earned rewards. As one example, when a student has earned a reward, the rewards component can instantaneously award a Starbucks Gold Card to the student, allowing the student to make a purchase directly. As another example, a student may enter a Starbucks store and want to see if he has a reward with the merchant. The student can choose to view his rewards from a user interface provided by the reward-based learning system 140. When the student chooses a particular reward to redeem, the student may then be presented with a corresponding electronic coupon code that may be communicated to a point-of-sale at the Starbucks store.

In some embodiments, the education component 612 interacts with one or more education systems to supply a learning process to a user. It may allow an education system to upload education contents, including questions, answers, media links, audio, videos, eBooks, etextbooks, and the like. The upload may be performed using one of a variety of protocols, including FTP and web-services. In addition, the education component 612 may allow an education system to sign up for a location-based feature. In that case, it may enable an education system to directly receive a user's GPS coordinates to determine whether the user is where he is supposed to be, such as a particular classroom, or it may track a user's GPS coordinates and forward the user's location information to the education system. For example, on certain days of the week, a third party might require a device user to: (1) show up and check in to a school location by a certain time; (2) check in as still at school at the end of the school day; (3) check in at home by a certain time; or (4) check in at home later in the evening to prove the user is still there as a way of engaging in a learning process. The education system may then customize the learning process to include unique learning questions or instructions to confirm that the end user and the end user's device are in the specified coordinates requested by the third party.

In some embodiments, the assessment component 602 assesses each student to profile each student's preferred learning patterns with respect to the three factors discussed above, individually or in any correlated manner. An assessment test can be administered via a user's electronic computing device (or combinations of electronic computing devices). The purpose of the assessment test(s) primarily is to determine two aspects of the student's learning: 1) optimal reward timing in terms of the learning activity status; and 2) optimal nature of the actual reward, so as to maximize the student's learning. Common subject matter may be covered in the testing, such as reading comprehension, pattern recognition, memory, and basic math skills. The assessment component 602 may conduct various assessment tests, as described below. This is a particularly relevant to “adaptive learning”.

FIG. 7 is a diagram illustrating an assessment matrix. In this example, the action of the student with respect to reward timing is considered the primary motivating factor. In other examples, the nature of a reward may be considered the primary motivation factor. In this example, the content of the learning process may serve as an additional dimension in the assessment. For illustrative purposes, different subject matters are considered: Math, Pattern Recognition, and Reading Comprehension. For each subject matter, varying levels of difficulty are also introduced to enhance the assessment analysis and results.

For example, one student may find that he is most effective first thing in the morning after breakfast when powering his device (i.e., initiate use of electronic device) (see column “Action of the Student”). However, another student may find she is more efficient to perform at the middle level material when the device is already on (e.g., engaged in the use of education content) (see column “Action of Student”). Further still, she may find that the most difficult material is efficiently completed when she has completed her learning material (e.g., complete the education content) (see column “Action of the Student”). In another example, another student may find that he learns best when he has received access to his reward (e.g., receive access to target reward content) (see column “Action of Student”). For others, it could be any combination which is why the matrix approach is important. The matrix enables flexibility in when to introduce different levels of material difficulty. This assessment should not be confused with the target education content.

FIG. 8 is a diagram illustrating example levels of difficulty for various Math tests. Three levels of difficulty are shown. For each subject matter and level of difficulty combination, the assessment may include measuring a student's performance against a predetermined standard and characterize the student's preferred reward-based learning experience with respect to reward timing, subject matter, level of difficulty, and other factors. For example, the student would need to obtain a score of at least 75 on a test to be considered as being effective under the test circumstances.

In the case of the Easy Level Math, four types of questions are illustrated whereby single digit calculations for multiplication, division, addition and subtraction are provided. In this example, a student would be provided 30 questions to answer in 60 seconds. In one instance, an analysis would include accuracy and speed. In another example, the analysis could include a proximity factor to understand the nature of an incorrect answer. For example, a relative difference of inaccurate answers can be created when the answer to 3+3 is 6 vs. 33. Additional assessments techniques are well known to those familiar with assessment tests and in particular the identification of individual strengths and weaknesses.

In the case of the Moderate Level Math, four types of questions are illustrated whereby single digits applied against double digit calculations for multiplication, division, addition and subtraction are provided. In this example, a student would be provided 20 questions to answer in 60 seconds. In one instance an analysis would include accuracy and speed. In another example, the analysis could include a proximity factor to understand the nature of an incorrect answer. For example, a relative difference of inaccurate answers can be created when the answer to 19-10 is 10 vs. 29. Additional assessments techniques are well known to those familiar with assessment tests and in particular the identification of individual strengths and weaknesses.

In the case of the Higher Level Math, four types of questions are illustrated whereby double digit calculations for multiplication, division, addition and subtraction are provided. In this example, a student would be provided 15 questions to answer in 60 seconds. In one instance an analysis would include accuracy and speed. In another example, the analysis could include a proximity factor to understand the nature of an incorrect answer. For example, a relative difference of inaccurate answers can be created when the answer to 72/12 is 6 vs. 12. Additional assessments techniques are well known to those familiar with assessment tests and in particular the identification of individual strengths and weaknesses.

In each of the cases of the relative difference of the inaccurate answer, one could easily identify patterns of sloppy calculations compared to a lack of understanding the fundamentals. This would be familiar for one in the educational field to determine with the use on analytical techniques. The assessment is a particularly relevant place to, among other considerations, utilize additional analytical aspects such as bio-physical such as optical scanning. For example, a simple cross-check can be conducted to compare the end users average reading speed (as determined by number of words read by number of seconds) and compare that speed to the speed to sections where a learning problem surfaces. Further to the analysis can include an analyses of the eye engagement as determined by the optical scanning features of smart devices.

FIG. 9 is a diagram illustrating example levels of difficulty for various Pattern Recognition tests. For pattern recognition activities, three levels of difficulty are provided. In the case of the Easy Level Pattern Recognition, one type of question is illustrated whereby up to two digit patterns of numbers and letters are provided. In this example, a student would be provided 10 questions and 3 seconds to answer each. One familiar with education would realize that the digit patterns could easily be pictures, symbols, sounds, movements, etc. An analysis would include accuracy and proximity. For example, a relative difference of inaccurate answers can be created when the pattern is 4W, but the answer is W4 vs. XY. Additional analytical techniques are well known to those familiar with the identification of individual strengths and weaknesses.

In the case of the Moderate Level Pattern Recognition, one type of question is illustrated whereby up to four digit patterns of numbers and letters are provided. In this example, a student would be provided 10 questions and 3 seconds to answer each. One familiar with education would realize that the digit patterns could easily be pictures, symbols sounds, movements, etc. An analysis would include accuracy and proximity. For example, a relative difference of inaccurate answers can be created when the pattern is W8P, but the answer is W8 vs. 2PZ. Additional analytical techniques are well known to those familiar with the identification of individual strengths and weaknesses.

In the case of the Higher Level Pattern Recognition, one type of question is illustrated whereby five or more digit patterns of numbers and letters are provided. In this example, a student would be provided 10 questions and 3 seconds to answer each. One familiar with education would realize that the digit patterns could easily be pictures, symbols sounds, movements, etc. An analysis would include accuracy and proximity. For example, a relative difference of inaccurate answers can be created when the pattern is K6A0E, but the answer is K6AE vs. 9ZLK. Additional analytical techniques are well known to those familiar with the identification of individual strengths and weaknesses.

In each of the cases of the relative difference of the inaccurate answer, one could easily identify patterns for learning disabilities, such as dyslexia or stunted or diminished memory. This would be familiar for one in the educational field to determine with the use on analytical techniques.

FIG. 10 is a diagram illustrating example levels of difficulty for various Reading tests. Three levels of difficulty are provided. In the case of the Easy Level Reading, a multiple-choice set of questions is illustrated based on a reading passage composed of short and simple sentences. In this example, a student would be provided 2 questions and all the time they required. One familiar with education would realize that the reading passage could be made available for a specific time period and then disappear when the questions are asked. Alternatively, the reading passage could be preceded by the questions. An analysis would include accuracy and proximity as well as other learning measurements such as reading speed. Further, to the embodiment of this invention the reading section of question set could be separately prepared such that time could be recorded for the reading of the passage compared to the reading of the questions. In other words, does the student's reading speed change when reading background information compared to questions and answer options. Further, still, how many times does the student refer back to the reading passage? Perhaps for instance the student starts with the question and then just scans the reading passage. In yet another embodiment the reading passage could be read aloud and the smart device could record the reader's voice and conduct comparison analyses of the spoken words to a prerecorded words. Such comparison would reveal fluency or troubled areas. These patterns, analyses and more combinations can be easily determined by those familiar with the related art. For example, it is clear that Adam did not cook any fruit but meat is not specifically cited in the reading passage.

In the case of the Moderate Level Reading, a multiple choice set of questions is illustrated based on a reading passage composed of mostly simple sentences. In this example, a student would be provided 2 questions and all the time they required. One familiar with education would realize that the reading passage could be made available for a specific time period and then disappear when the questions are asked. Alternatively, the reading passage could be preceded by the questions. An analysis would include accuracy and proximity. For example, it is clear that a cheetah is not discussed in the reading passage.

In the case of the Higher Level Reading, a multiple choice set of questions is illustrated based on a reading passage composed of short and simple sentences. In this example, a student would be provided 2 questions and all the time they required. One familiar with education would realize that the reading passage could be made available for a specific time period and then disappear when the questions are asked. Alternatively, the reading passage could be preceded by the questions. An analysis would include accuracy and proximity. For example, it is clear that in order to answer question 2, one first needs to understand the definition of synonym.

In some cases, using just one level of difficulty may be sufficient. In other cases, it may be necessary to use combinations. For example, if someone is getting 100% on the lower levels, then it would be best to push them to the higher levels to learn if differences exist. In other cases, if the lower level scores are closer to 50%, there is no reason to frustrate the student with more difficult material. This is yet another example of “adaptive learning”.

The Assessment Test matrix is just one series of examples. In the illustrative example, the content is provided separately and independently from the education content that is the release mechanism for the reward. Once an initial assessment is made, the assessment component 602 may evaluate the results to identify patterns or trends along any dimension of the assessment. It may employ known discrete or statistical classification and pattern recognition techniques in analyzing the results. Some example factors for consideration are as follows:
The user's time to provide an answer to a question. This information can help identify trends, such as high aptitude areas as well as weaknesses in certain question-taking strategies (such as not reading all the answers provided to look for the best answer choice).
Trends to the time of day can help identify periods of the day where a user performs at higher and lower intellectual intensity.
Results from different core subjects compared together can be a useful tool in identifying learning trends based on interest. For example, a user who performs well in math, art, and science, but not geography could suggest the person is not engaged.
Results for cognitive versus pattern recognition can show brain development differences leading to new education strategies.
Results of how a user learns new information in terms of audio, visual and reading can lead to invaluable tools for enhanced learning.
Results of native knowledge, such as general understanding of physics and geography, compared with school knowledge, such as chemistry, are compared to the background information provided to the person taking the question so as to provide a more accurate evaluation of the performance of the user.
Results of question types, such as multiple-choice, true/false and fill-in-the-blank, can reveal test-taking strategies rather than academic subject weaknesses.
Trends of the day, week or month for optimal user testing performance can be helpful in assisting a user in scheduling their academic workload and standardized testing.
Trends related to age can demonstrate correlations with maturity.
Trends related to social activities may require isolation to confirm suspicions about trends of distractions. In particular, understanding the SMS activity or social networking activity before, during and after a session could reveal disturbing trends of social distractions.
Trends related to school test dates can be conducted with a simple interface with a student's calendar. Revealing anxiety the day before a scheduled test can create opportunity for subtle time management changes.
Trends of a user compared to those of his class, school, school district, state, etc. in a particular field of study can be of great value. For example, if the questions within the Learning Assessment system database were generated by a school district, a user could know, at any particular time, his competence compared to his peers.
Trends compared to results for similar subjects in a classroom could help reveal teaching/learning conflicts. For example, if the analyses showed that a user performs well on all math test questions, but not well on similar subjects in school, one can investigate the cause of the difference.
Trends compared to results obtained from aptitude tests, such as SAT, MCAT, GMAT.

In some embodiments, the assessment component 602 may extract a user's preferences in terms of one or more of the three motivating factors from a user's past learning experiences: 1) reward timing in terms of learning state; 2) reward timing in terms of learning activity status; and 3) reward category. It may obtain relevant information from written documentation of the user's past learning experiences, or interviews with the user as well as the user's supervisors, friends, colleagues, and other people who might have insight into the user's preferences. It may prepare questionnaires for the interviews aimed to solicit an interviewee's view on the user's learning patterns and trends.

Ultimately, the assessment component 602 may set up one or more reward-based learning profiles for each user indicating the user's preferences at least in terms of the three motivating factors. The profiles may later be used to provide the user with an optimal reward-based learning experience, as discussed below.

In some embodiments, the user module 606 manages interactions with a user of an electronic device. The user module 606 may allow a user or a third party to set up an account and register electronic devices owned by the user. The user module 606 may enable a user to perform a learning process. For example, it may display education contents to the user and accept the user's replies to the education contents. The user module 606 may also inform user of information regarding a reward or any error.

In some embodiments, the user component 606 tracks a user's learning state. As discussed above concerning the learning state, a user may be idle; demonstrating an effort, such as spending an extra thirty minutes reading on a subject; achieving certain milestones, such as passing a driving test; or just engaged in learning in general; and a reward may be given at chosen stages to provide the best learning motivation for the user. Therefore, the user component 606 may keep track of the number of questions a user answered, the number of chapters read, the test scores obtained, and other indicators of work done on each relevant subject matter. It may also maintain specific thresholds for determining whether the user's learning state falls in one of several stages. For example, a user may achieve a milestone by reading a specific number of chapters of the biology textbook within one night. This milestone could be cross-checked to, among other considerations, through the utilization of additional analytical aspects such as bio-physical and optical scanning. For example, a simple cross-check can be conducted to compare the end users average reading speed (as determined by number of words read by number of seconds) and compare that speed to the speed to sections where a learning problem surfaces. Further to the analysis can include an analysis of the eye engagement as determined by the optical scanning features of smart devices.

In some embodiments, the user component 606 further tracks a user's learning activity. Further, as discussed above concerning the learning activity, a user may be at different points of a learning process, such as the beginning or the end of a test, and a reward may be given at chosen points to provide the best learning motivation for the user. Therefore, the user component 606 may keep track of a user's progress with respect to a specific learning activity and maintain specific criteria for determining whether the user's learning activity status has reached one of the chosen points. For example, a user may be considered as completing a learning process upon answering more than 95% of the questions on a test.

In some embodiments, the enforcement component 608 offers a user a reward-based learning experience based on the user's profile as well as the user's current learning state and learning activity status. In general, the enforcement component 608 identifies the user's preferred reward timing with respect to the learning state and the learning activity status as well as the preferred reward type when a profile for the user is available. When the preferred rewarding timing is met, the enforcement component 608 then issues or attempts to issue the preferred type of reward to the user as a default. For example, it may deliver the preferred type of reward to the user online via the user's mobile electronic device. In this manner, the user can be expected to be highly motivated for the learning activity, achieve the best learning result, and receive the desired reward. On the other hand, the enforcement component 608 may also respond to a user's request that deviates from the user's profile. For example, even if the user's most preferred reward is playing a specific video game for as long as possible, the user may sometimes choose to receive a gift card offered by a particular retailer instead. The enforcement component 608 may also respond to a user's request in the absence of a user's profile.

In some embodiments, the enforcement module 608 also handles exceptions. For example, it may allow a user to receive a reward without completing a learning process. When the reward is access to the user's electronic computing device, the enforcement module 608 offers such exception handling by allowing the user to override the default access blocking in emergency situations. For example, by inputting in a preset code into the device, the user can gain limited access to the device to place an emergency call (e.g., VoIP to emergency responders or to a third party associated with their account on the system server); or to gain access to email, text, instant messaging, or the like functionality on the device for transmission of electronic communications to designated contacts (e.g., mobile numbers for calls or texts, email addresses, etc.). The code for overriding access blocking may be a personal code designated by the user, or it may be a universal code for all users of the gateway system 240. The code may also be input into the device via keystroke, touch input to a touch screen, or audio input. Additionally, every instance of the user's emergency override may be recorded and electronically conveyed instantly to the monitor affiliated with the user's record.

FIGS. 11A and 11B are diagrams illustrating an instant override feature. In each case, the override provides for bypass of the learning modules so that the device can be used for emergency contacts or the device can be used by a third party in such a manner that the user is not forced to respond to the education content. FIG. 11A is an user interface diagram illustrating an example emergency override feature that can be requested by pressing the button 1110 on the user's electronic computing device, for example, but those well-versed in the art will understand multiple alternatives are available. The emergency override feature may be downloaded as an external application 1102 or incorporated into the operating system 1104. The emergency feature allows the end user to select two options. Option one is the emergency services that may be requested by pressing the button 1110a, for example, which connects the user to the local authorities such as fire or police or 911. Option two is the emergency contacts feature that may be requested by pressing the button 1110b, for example, which allows the user to select and contact a predetermined emergency contact list such as parents and friends. This emergency override system connects to emergency services that are offered by the various network providers for smart phones, such as AT&T Inc., on a standard basis.

FIG. 11B is a user interface diagram illustrating an example third-party override feature that may be requested by pressing the button 1112 on the device, for example, but those well-versed in the art will understand multiple alternatives are available. The third-party override feature may similarly be downloaded as an external application 1102 or incorporated into the operating system 1104. The third-party override feature allows a third-party user to enter a custom four digit passcode via the field 1130a and submit the pass code via the field 1130b, which unlocks the user's electronic computing device to its normal functionality. For instance, a parent may share a mobile phone with a child and want to use the phone without answering questions to unlock the mobile phone. The parent would select the third-party override feature, enter the known four digit passcode, and then submit the answer.

In some embodiments, the update component 604 allows a user's reward-based learning profile to be set up or updated based on the user's actual learning experiences. A user may not have a profile set up already or may act differently from the preference indicated in a profile. Therefore, a user may request a specific reward at specific learning states or at specific points during a learning activity regardless of any profile. The update component 604 may record and analyze these requests and set up or update profiles for the user when these requests exhibit patterns, for example. Therefore, the update component 604 enables a user's profile to be set up in an alternative manner and properly maintained.

Several examples of a reward-based learning experience for a user are given below.

### Example 1

A student has elected to participate in a Purely Random Reward Timing under “Reward Trigger” (first factor). In addition, the student has elected to join the Progressive system. The student was previously assessed as one who learns best when he is already engaged in his education content under “Student Action” (second factor). The student is working on a test preparation for a General Education Development (GED) on a tablet device, such as an iPad, when he decides to stop his learning module. At this time, which is an arbitrary time after he starts working on this test preparation, he is notified of a reward to purchase items on his iPad via email. He learned of his reward because Apple was able to contact him through a cloud connection with the reward-based learning system 140.

### Example 2

A student has elected to participate in a Demonstrating Effort Reward under “Reward Trigger”. In addition, the student has elected to have GPS Reward Content under “Reward Category” (third factor). The student was previously assessed as one who learns best when she is initiating the use of her electronic device under “Student Action”. The student is standing in line for coffee at a Starbucks when she turns on her smart phone. She is asked a series of learning questions related to her Anthropology class when she is alerted on her smart phone via text message that Starbucks is offering her a credit as a reward to purchase a retail item. Starbucks was able to offer her the reward because she was within a prescribed area of GPS coordinates.

### Example 3

A student has elected to participate in the Achieving Milestone Reward Timing under “Reward Trigger”. The student was previously assessed as one who learns best when she has completed her education content under “Student Action”. The student is walking home from school when she walks into Walmart. Walmart sends her an instant message that she is eligible for a custom reward, such as a discount, because she has passed her English test with flying colors. Walmart was able to offer her the reward because through a cloud connection with the reward-based learning system 140.

FIG. 12 is a flowchart illustrating an example process performed by the reward-based learning system 140 to set up profiles for users and provide users with optimal reward-based learning experiences based on the profiles. In step 1202, the reward-based learning system 140 enables ordinary reward-based learning experiences. One such experience may comprise a user's requesting a reward, receiving an education or learning task, demonstrating a satisfactory performance, and receiving a reward, for example. In general, however, a user may explicitly request a reward or exhibit a low level of motivation, patience, comfort, etc. to which the receipt of a reward may be helpful at any time during a reward-based learning experience. Therefore, in step 1204, the reward-based learning system 140 may capture a user's learning and reward preferences from the user's current reward-based learning experiences. In step 1208, the reward-based learning system 140 may also acquire a user's learning and reward preferences by examining the user's past learning experiences. For example, it may analyze existing, written documentation or conduct interviews with the user and other relevant parties regarding those learning experiences. In step 1206, the reward-based learning system 140 may also learn about a user's learning and reward preferences by systematic assessments based on predesigned learning experiences, which may cover education and learning processes of different degrees of difficulty, for example. It may provide controlled environments for the education and learning processes and extract specific insight on a user's learning patterns and trends with respect to materials on different subject matters and of different levels of difficulty. With these different approaches, in step 1210, the reward-based learning system 140 may set up and maintain one or more reward-based learning profiles for each user. In step 1212, it may then manage optimal reward-based learning experiences for each user based on the user's one or more profiles. This optimal reward-based learning is an extension of the behavior science covering unique and customized rewards.

In this instance the reward based learning system 140 is incorporating an “adaptive reward” element can be applied where as the student answers questions correctly and the questions (and or question types) get more challenging the rewards become more dynamic and customized. Alternatively, as the student answers questions incorrectly, the questions (and or questions types) get less difficult and the rewards can become more dynamic and customized. The “adaptive reward” can incorporate additional features such as those described elsewhere in this document pertaining to facial recognition and optical scan analyses. In these instances the electronic computing device used by the end user serves an additional purpose by measuring bio-physical aspects of the end user to enhance their learning experience. In other words, some end users may form disgruntled looks on their faces or roll their eyes when they are frustrated with the learning objective. It is an intent of this invention, among other things, to intercept the learning experience before the end user answers a question incorrectly by changing the value of reward (and thereby increasing motivation). The same bio-physical observations can be made with reward selection and assignment and therefore the same interception strategy can be followed. Bio-physical observations include sound level detection, heart-rate, blood pressure, sleeping pattern, etc.

It should be noted that the “adaptive learning” and the “adaptive rewards” can be used in a synchronized manner where each is responding to the other. For instance, as the questions become more difficult the reward can get more enticing. Conversely, the rewards can become more enticing as a prelude to introducing more difficult questions. An intent of the invention is provide rewards for the learning that respond to the individual learner's preferences as determined by the learner, teacher or computer software system evaluating and monitoring the device.

FIG. 13 is a flowchart illustrating an example process performed by the reward-based learning system 140 to manage a user's optimal reward-based learning experience. In step 1302, the reward-based learning system 140 sets up a profile for a user. In step 1304, the reward-based learning system 140 tracks the user's progress, especially in terms of the user's learning state and learning activity status. The user may be engaged in learning processes at various times and may be in different learning states with respect to different subject matters. The reward-based learning system 140 may work independently or with a learning and education system to keep track of the user's learning states with respect to different subject matters based on the quantities of education material reviewed, numbers of test questions attempted, test scores, and additional indicators. Furthermore, the user may start each learning process on his initiative or as a result of requesting a reward in the first place. The reward-based learning system 140 may also work independently or with a learning and education system to monitor the user's learning activity status. For example, it may send a test to a user in an incremental manner, 10% of the questions at a time. In step 1306, the reward-based learning system 140 checks whether the user has reached a preferred learning state for receiving a reward, such as achieving a milestone. If the answer is no, it continues to track the user's progress; however, if the answer is yes, in step 1308, it checks whether the user has reached a preferred learning activity status, such as completing a learning process. If the answer is no, it continues to track the user's progress; however, if the answer is yes, in step 1310, it attempts to send the user's preferred reward to the user. At that time, the user may refuse to accept the reward or decide to receive another reward. At any other time, the user may also request or show a desire to receive a reward. In general, when the user deviates from the specifications in the profile, the reward-based learning system 140 may update the user's profile when it judges that the deviating behavior is becoming a norm.

FIG. 14 is a diagram illustrating example components of an adaptive learning process. In some instances each of the components is provided within a single electronic computer device (such as a smart phone), in other instances the components are provided in multiple devices including those that are connected directly or via a cloud type system. The first component is the Learning Agent 1440, the second component is Reward Timing 1450 and the third component is Reward Type 1460.

In some implementations, the learning agent 1440 may be comprised of five feature sets. Each feature set is intended to provide an example of the different types of learning agents or mechanisms that are relevant to a learner. The five feature sets that are provided are provided as examples for illustration purposes and are not a limitation of this invention.

The first feature set is “read” 1402 and this comprises a traditional approach to learning in that a form text would provide a series of information that would provide learning. For instance, in the case of learning about the basic features of a cell being comprised of a membrane, a cytoplasm and nucleus, a student could simply read from a text book or an eBook. The second feature set is “hear” 1404 and this comprises an approach to learning that is all based on hearing and sound. For instance, in the case of the basic features of a cell the student would listen to the relevant information via a headset of a recording or of a live remote lecture for example. The third feature set is “watch” 1406 and this comprises an approach to learning that can include a combination of reading and hearing or each individually. For instance in the case of the basic features of the cell the student would watch a video, an animated story or a live lecture where information is written on a board or eBoard and the instructor is speaking along with the presented material. The fourth feature set is “interactive” 1408 and this comprises an approach to learning that involves an interaction with the student. For instance in the case of the basic features of the cell the student would have an interactive puzzle or ePuzzle where by each of the major parts are presented and the learner must assemble the individual parts to demonstrate a mastery (or level of learning). The fifth feature set is a “combo” 1410. The learning agent 1440 can be “adapted” for each learner based on their particular learning style. In some cases an individual learner may have a preference for learning new information in the form of Reading 1402 and then reinforcement learning (review of material verses new material) in the form of Interactive 1408 (or vice versa). Further still, some individuals may require a combination that includes using different agents within a single topic based on levels of material, periods of time or combinations.

In some implementations, the reward timing 1450 may be comprised of five feature sets. Each feature set is intended to provide an example of the different types of reward timing (time of granting a reward relative to time of accomplishing a task) that are relevant to a learner. The timing of the reward is relevant to a learning process because some learners need immediate gratification while others would prefer a randomly inspired reward. Further still, some learners require combinations. The five feature sets that are provided are provided as examples for illustration purposes and are not a limitation of this invention.

The first feature set is “now” 1412 and this comprises a traditional approach to reward timing that would provide a reward at the completion of each correct answer (or completion of a targeted learning milestone such as reading a page of watching a video). For instance, in the case of learning about the basics of multiplication the learner would be rewarded immediately after answering each individual question correctly such as 6×6=12. The second feature set is “periodic” 1414 and this comprises an approach to reward timing that provides the learner with a reward at a fixed interval of time or frequency. For instance, in the case of the basics of multiplication the learner would be rewarded every nth time (such as every 10th correct question or every 10th minute of being engaged). The third feature set is “now” or waiting 1416 and this comprises an approach to reward timing that provides the learner with a reward at the end of a session or end of multiple sessions. For instance, in the case of the basics of multiplication the learner would be rewarded at the end of a particular session (such as completing all exercise related 6's). The fourth feature set is “random” 1418 and this comprises an approach to reward timing that provides the learner with a reward at a random point in a session. For instance, in the case of the basics of multiplication the learner would be rewarded at any time of a learning session including the first to third feature sets. Moreover, it would involve any time from starting point of engagement to termination point of a session. The fifth feature set is a “combo” 1420 and this comprises an approach to reward timing that involves any and all combinations of the four sets. For instance, in the case of the basics of multiplication the learner could be rewarded at different levels of engagement whereas learning the 1's provides one type of reward and learning the 9's provides another type of rewards. For example, in some cases an individual learner may have a preference for learning new information in the form of “now” 1412 reward and then reinforcement learning in the form of “random” 1418 rewards. Further still, some individuals may require a combination that includes using different rewards within a single topic as the learner develops mastery skills.

In some embodiments, the reward type 1460 is comprised of five feature sets. Each feature set is intended to provide an example of the different types of reward type that are relevant to a learner. The type of the reward is relevant because some learners need specific inspiration. The five feature sets that are provided are provided as examples for illustration purposes and are not a limitation of this invention.

The first feature set is an “ap” 1422 reward and this comprises an approach to a reward type such as access to an individual application on a smart device. For instance, in the case of learning about the basics of multiplication the learner would be rewarded, at the achievement point of a milestone, with access to an electronic device application such as Angry Birds®, calculator, including both those critical to the operation of the electronic device as well as those that are downloaded from app store such as Google Store. The second feature set is a “device” 1424 reward and this comprises an approach to reward type such as access to all functionality of an electronic device (or multiple devices or combinations of applications within device). For instance, in the case of learning about the basics of multiplication in which an achievement point is realized the learner would be rewarded with access to all of the functionality of a game console such as a Xbox or a smart phone. The third feature set is a “money” 1426 reward and this comprises an approach to reward type such as being granted access to (or being provided) money or a recognized currency. For instance, in the case of learning about the basics of multiplication in which an achievement point is realized the learner would be rewarded with access to money from a PayPal® account. The funding source can include a teacher, parent or corporate sponsor. The funding can take place electronically on the targeted device used for learning in one case. The funding source can include a teacher, parent or corporate sponsor. The fourth feature set is a “retail” 1428 reward and this comprises an approach to reward type such as being granted access to a retail gift card, prize, etc. For instance, in the case of learning about the basics of multiplication in which an achievement point is realized the learner would be rewarded with a gift card from Target. The funding source can include a teacher, parent or corporate sponsor. The fifth feature set is a “combo” 1430 and this comprises an approach to reward timing that involves any and all combinations of the four sets. For instance, in the case of the basics of multiplication the learner could be rewarded at different levels of engagement whereas learning the 1's provides one type of reward and learning the 9's provides another type of rewards. For example, in some cases an individual learner may have a preference for learning new information in the form of “ap” 1422 reward and then reinforcement learning in the form of “retail” 1428 rewards. Further still, some individuals may require a combination that includes using different rewards within a single topic as the learner develops mastery skills.

In some implementations, an adaptive (or responsive form) of tabulating all of this information may be constructed for each individual as a custom profile using the gridlines in FIG. 14. Thus, a learner can be profiled against each of the three components, learning agent 1440, reward timing 1450, and reward type 1460. With this profile a responsive system could analyze past performance and anticipate current and future performance thereby providing the targeted learner with custom learning agent, customer reward timing and reward type.

With respect to a classroom or teaching environment with multiple learners this adaptive approach may be particularly effective for an eClassroom where each student is using an electronic device. In this particular instance, the electronic device can be the vehicle that provides the rewards and administers the decisions. Alternatively, the analyses and reward types can be hosted from a cloud-based system. A teacher could administer entirely custom experiences for each of her students by relying on the feedback collected through integrated system.

In one example, a teacher is teaching a classroom of children biology. The lesson is a simple overview of the cell which is composed of membrane, cytoplasm and nucleus. The teacher presents the class objective—learning about the cell. The children are then directed to a series of learning material such as paragraph explanation, an illustration, a video, and an interactive exercise. Furthermore, the children are given reward options which range from social media time to game time. Each are subjected to a test and the test is provided in either written, visual or audio.

Using this adaptive and highly customized approach, incorporating algorithms common to one familiar with the art, to determine what learning material is most appropriate (and the targeted level of language) for the individual, combined with the history of rewards (based on level of difficulty and attention span) the learning experience is optimized. This can include the venue of the test (i.e. written/oral etc.) In other words, if an objective is to get the child to understand the individual differences of membrane, cytoplasm, and nucleus then the method by which they children learn the targeted learning and prove they have mastered it is secondary.

In yet another example, each of the components learning agent, reward timing and reward type can be further interconnected to bio-physical elements (discussed in detail in earlier) so that important patterns of the students learning anxiety and excitement may be included in the process. For example, the system could determine through bio-physical elements a student is experiencing anxiety despite the custom experience. In this case, the system could introduce a surprise reward or reduction in learning material difficulty at a sequence until the bio-physical signs stabilize.

### Sound Level Control

A voice decibel mechanism that will shut down the software system (or otherwise modify the reward portion or the earning portion if the electronic device detects a sound emitted from the user (or from the smart device itself) at a level higher (as measured in decibels) than a pre-set (or personalized) limit. One familiar with voice decibel systems and the widely available applications to record and detect the decibel level from the electronic device would understand the manner in which the hardware of the electronic device already contains the detection and measurement equipment. In particular, the U.S. patent application Ser. No. 13/568,950 describes many of the features capable of being monitored by the electronic device. This feature disclosed in various embodiments may be particularly useful in a classroom setting where one student might be enjoying a privilege he earned by playing a game while another student is still earning time. In other words, in a classroom setting, when the student is enjoying their reward, he may elect to play a game such as Angry Bird. If the student had the volume too high or was laughing too loud the sound level control would intercept the session. However, any other environmental settings where the sound level is concerned are relevant as well.

Optionally, in one example, the sound level control could simply remove some or all of the time that was earned during session with this invention if a sound level exceeded the established threshold. Further, the sound level control could send out a warning, in the form a dropdown message (like a banner add) before taking an action of shutting down or removing time. In the case of the volume of the device exceeding the established limits the device could adjust itself to the appropriate level or simply eliminate its sound emitting capability for a specific time, or event such as use of a particular application or function. Alternatively, the sound level detected by the electronic device could be used to measure the excitement of the end user engaged in the learning objective. For example, a person excited about completing a module could exert sounds of exhilaration. Conversely, someone frustrated with the learning experience could exert grunts of frustration. One familiar with the art of language and human sound could understand the nature of the differences of the sounds and their implications on learning.

In yet another example, a toy's operation could be influenced by sound level detection. For instance, a boy operating his interactive robot could have his robot cease operation (or provide a warning) when the boys voice exceeds a certain threshold. Similarly, a girl engaging with her interactive doll could have her doll cease operation (or provide a warning) when the girl's voice exceeds a certain threshold.

### Special Needs Population

It is also noted that the features discussed in various embodiments of this invention are suitable for use in a variety of situations beyond parent/child and teacher/student, such as by employers training employees, clinicians engaging in rehabilitation of patients who are mentally impaired, etc. For example a child with autism could be provided with educational content on basic hygiene routines, while an adult with Alzheimer's could be provided with education content on family history. The features of this invention may also involve self-monitored learning by an individual who has elected to master a new subject (e.g. foreign language) or exercise their intellect (e.g. memory and analytical exercises for an aging individual). In this scenario, the individual would function as both the system “user” and “third party” by selecting the scope of access denied to the device, such as the entire device or the Internet, or the Facebook® website, etc.; and being provided the analyzed results of their progress directly from the system server.

In another example the electronic device could be used for monitoring the movement via a range of electronic devices such as a smart phone, smart watch or smart glasses. A movement in a targeted motion or position that is part of a learning or training program would be rewarded by providing expanded or full functionality of targeted electronic device(s).

Notwithstanding the examples and references with an emphasis on educational learning, the system and method disclosed in various embodiments of the invention are of particular relevance to other learning applications and conditions or third-party controlled instructions or requests such as, but not limited to, those in medical rehabilitation, hospital patients, special needs children, employee, professional groups (such as accountants, doctors, and lawyers who require annual continued professional credits), specialized training courses, athletic training, physical education, military training, trivia, pre-natal care, emergency response, farming basics, sanitation and infectious disease prevention, domestic violence awareness, and so forth.

As a particular example using a patient reducing brain deterioration with customized mental exercises: A medical-dementia patient elects to use the network as a gateway where for example she informs AT&T Inc. to enable only enable her critical communications including television satellite until after she achieves specific targets on brain exercises. She selects the education venue so that she could identify the precise elements of her brain between cognitive and pattern recognition that were further diminished. These areas then become the priority in her daily exercises. For her reward, she selects retail such as a meal at Denny's restaurant (including senior citizen discount for mental game progress)

### Facial Recognition

In yet another instance of analytical mechanisms, facial recognition software such as programs created to track the “face print” can be incorporated into the analytical process by which a learner is engaged in a series of questions or instructions. For example, a “face print” is a series of various relative positions of various data points on a given face (e.g. nose, eyes, lips, eye brows, etc.) these different data points can be used to determine not only the face print (or the person to whom the face belongs) but the individual data points can also reveal the mood of the face (happy, sad, angry). When compared to the time to answer a question or the level of difficulty (including type of question) the tracking of the facial expression of mood would provide valuate analytical information to those familiar with the art of teaching and learning including adaptive learning. In one of many examples known to those in the level of difficulty to a question could be changed before the student even answered the question. In other words, instead of waiting for the student to submit an incorrect answer before changing the level of difficulty an adaptive program could change the reduce the level of difficulty as the expressions become more frustrated (frown) or increase the level of difficulty as the expressions become more excited (smile or laugh gesture).

In yet another example, a toy's operation could be influenced by facial gestures. For instance, a boy operating his interactive robot could have his robot change operation (or provide a warning) when the boys face indicates frustration. Similarly, a girl engaging with her interactive doll could have her doll cease operation (or provide a warning) when the girl's face indicates sadness.

### Optical Scan Analysis

Examples of common eye movement patterns include the following: Visual Construction, looking up and to the left. The person is accessing information from their imagination and might possibly be making it up; Visual Remembering-looking up and to the right. This is when the person is actually accessing a memory and picturing it in his head. Auditory Construction-looking middle and to the left. This is where a person's eyes might go if he was constructing a sound in his mind; Auditory Remembering-looking middle and to the right. This is where a person's eyes might go if he was remembering a sound that he had heard previously; Kinesthetic-looking down and to the left. This is the direction a person's eyes might go if he was accessing his actual feelings about something; and Auditory Digital-looking down and to the right. This is the direction a person's eyes might go when he is talking to himself. All of these provide a new insight that would be a powerful analytical tool to helping and end user better learn or perform the instructions.

Further still, the pupils can be observed and changes in the pupils size (dilation) can provide a new dimension into a student's learning process or an individuals behavior modification. More specifically, the size of the pupils (dilation) can indicate whether the end user is experiencing a higher (larger pupil size) or lower (smaller lower pupil size) challenge based on an optical tracker. This evidence can contribute to the learning material being introduced to the end user so it can be adjusted upward or downward (in difficulty) based on the desired learning platform.

As background, pupil dilation generally correlates with arousal so consistently that researchers use pupil size, or pupillometry, to investigate a wide range of psychological phenomena. Stimulation of the autonomic nervous system's sympathetic branch, known for triggering “fight or flight” responses when the body is under stress, induces pupil dilation. Whereas stimulation of the parasympathetic system, known for “rest and digest” functions, causes constriction. Inhibition of the latter system can therefore also cause dilation.

In one study, a scientist observed that when he instructed subjects to remember and recite a series of seven digits, their pupils grew steadily as the numbers were presented one by one and shrunk steadily as they unloaded the digits from memory. Subsequent research found that the pupils of more intelligent people (as defined by their Scholastic Aptitude Test scores) dilated less in response to cognitive tasks compared with those of lower-scoring participants, indicating more efficient use of brainpower.

In an example, a toy's operation could be influenced by level of eye engagement. For instance, a boy operating his interactive robot could have his robot change operation such as power down or become more engaging (or provide a warning) when the boys eyes reveal he is uninterested or is getting very excited. Similarly, a girl engaging with her interactive doll could have her doll power down or become more engaging (or provide a warning) when the girl's eyes reveal she is uninterested or is getting very excited.

### Wearable Smart Devices

Wearable smart devices, in simple terms, are attempts to free data (and other calculating aspects like movement, environmental measurements, calorie consumption, calories burned bio-monitoring, etc.) from desktop computers and portable devices. More specific examples include devices that tracks steps (and stairs) as well as sleep with a vibrating alarm, including an “optimal” wake-up window, that analyzes motion so one can be waken up during the lighter portions of his sleep cycle rather than jarring him awake in the middle of deep sleep.

Many are designed to have Bluetooth®, WiFi and GPS built in. This enables the devices to be used as standalone smart device or in combination with another smart device such as a phone, tablet, etc.

There are different companies that have already emerged with different versions of wearable smart devices and they include Fitbit® offerings, Google Glass®, Samsung Galaxy Gear®, GreenPeak® offerings, InvenSense® offerings, Lumus® offerings, Motorola Solutions® offerings, Nike FuelBand®, Vuzix® offerings and Withings® offerings.

Notable examples of commercial items that one familiar with the art would realize could be interchangeable with the traditional smart devices used such as phone, tablet, game counsel, smart tv, automobile include the products from Fitbit Inc. and Google Inc.

Fitbit Inc. offers several different products that include: Flex™ wireless sleep and activity tracker bracelet that tracks movement, calories consumed, sleeping, etc., Zip™ wireless activity tracker a clip on device that tracks steps, distance, calories burned, stairs climbed and sleep, Aria™ wifi weight scale (a standard home use scale configuration) that tracks weight, body mass index. Each of these devices and all of the information are sent via number of electronic methods where the information is tracked and summarized on the cloud or personal electronic device. Fitbit Inc. also offers an open API so many of the data captures can be shared and included with developments and applications.

Essentially, a Google Glass® is a camera, display, touchpad, battery and microphone built into spectacle frames so that you can perch a display in your field of vision, film, take pictures, search and translate on the go to name a few features. Bluetooth® and Wi-Fi will be built in. A user may user her Google Glass® to interact with the gateway system discussed in various embodiments. The Google Glass and other smart devices may be locked down until targeted learning is completed. They can also provide signals that can be used to support the decision of whether a learning objective was met.

Further, the signals can be used to help contribute to important vital signs of the student or end user and that information can be used to compliment the analytic information that contributes to the “adaptive” learning. Further still, signals from devices like scales can be incorporated into the invention to help an end user learn how to better manage and understand their weight condition. For example, the instruction for an end user could be to weigh himself each morning and record the previous days physical activity and calorie consumption. Until this instruction is followed the target electronic device (or devices), with exception of scale in this case, are locked until the instruction is completed.

### “Smart” Systems for Automobiles

“Smart” car systems such as those offered by Ford Sync® include a range features that can be synchronized. To power Sync, Ford Motor Company partnered with Microsoft Corporation for the software. Microsoft Corporation created Microsoft Auto software, which can interface with just about any current MP3 player or Bluetooth® cell phone. Passengers can connect their cell phones through Sync's integrated Bluetooth technology. The software will seek the address book and transfer the names and numbers to an internal database. Like many existing Bluetooth cell phone links, Sync is capable of voice-activated, hands-free calling. Push a button on the steering wheel, and you can speak the name or number you wish to call.

Sync diverts from the traditional Bluetooth® path by utilizing text-to-speech technology to read aloud any text messages you might receive while driving. The system can translate commonly used text message phrases such as “LOL” (laughing out loud). In turn, you can reply to an audible text message from one of 20 predefined responses. Sync® also supports many of the other features found on cell phones, including caller ID, call waiting, conference calling, a caller log, and signal strength and battery charge icons. When you receive a call, Sync can play personal ring tones, including special tones for specific callers. All this information is shown on the radio display screen.

As Sync® primarily runs on software, the system is upgradeable. Ford Motor Company and Microsoft Corporation have plans to allow dealer service technicians to perform updates when the vehicles are in for scheduled maintenance. Updates may also be available on a Web-site for consumers to download and install.

Since the introduction of Sync in the 2008 model year, other car makers have launched similar systems. General Motors Company has expanded its OnStar® service and integrated Sync-like features into its infotainment system, and has even added smartphone apps so drivers can do things like unlock and start their cars remotely. Hyundai Motor Company is launching its Bluelink® service on some 2012 models. Bluelink not only has things like vehicle tracing and crash notifications services, but also includes features like Bluetooth® integration, and location services that allow your car to check in at various locations—something that's helpful if you're a social media fanatic.

### Lottery Style Rewards

The gateway system can include a progressive lottery type of syndicate whereby it is a linked system. In this system a group of students join into a particular type of learning or sign up for a particular type of reward that is provided by a corporate or retail sponsor. For example a group of students studying similar content for a test prep such as the SAT could all compete for a random reward. Specifically, the commonalty is the SAT content and they are each competing for a randomly generated reward. Conversely, a group of employees within a large organization with multiple locations around the world could sign up for a specific reward (such as additional vacation time, a gift certificate for coffee, etc.) regardless of their job training content. Specifically, the commonalty is not the learning content—it is the specific reward.

In another case, the students could wager their accumulated time against each other whereby a single winner (or group of winners) take all or the majority of the collective time. This could be done on an individual, class or school level including any combination of participants. The competition amongst the students could include games one familiar with motivational behavior would know and include those games based on a skill or knowledge, a physical action (like running), a physical change (like gaining or losing weight), luck (like those associated with compulsion) or game of chance or any combination.

### Global Positioning Satellite (GPS) Systems

In the case of tracing GPS coordinates, many smart devices come with a built-in GPS function. The GPS function is a byproduct of using a smart device. For example, the built-in receiver trilaterates your position using data from at least three GPS satellites and the receiver. GPS can determine ones location by performing a calculation based on the intersection point of overlapping spheres determined by the satellites and your phone's GPS receiver. In simple terms, trilateration uses the distance between the satellites and the receiver to create overlapping “spheres” that intersect in a circle. The intersection is your location on the ground. This GPS feature has been incorporated into a number of native applications and web based applications that incorporate the smart devices user's location. Examples include Groupon®, Facebook® Nearby, and Eventseeker. In each of the examples, the smart device user can be informed when he enters a specific set of coordinates about a particular discount at restaurant, a friend's proximity or a an entertainment event. The “GPS coordinates” demonstrates what one familiar with the art could do to enable the smart device to become a tracking beacon for periods of time that include until a target event occurs or the passage of a prescribed amount of time.

Using GPS signals, the students are identified while in a Retail store and join the contest through their electronic devices. In one embodiment each of the students is in the same location in another embodiment the students are in different locations. In another example, students can represent groups of students in classrooms or any group, such as a church group. In lieu of the GPS coordinates, the activity of the contest could include any type of membership program that could allow students or groups, to enroll and compete in the contest from remote locations, through the cloud.

The assessment and gateway functions may further comprise utilizing location based content and calculating the location of the user via, for example, the use of global positioning system (GPS) capabilities on the user's electronic computing device. The user may be required to perform a physical task (e.g. running around neighborhood, walking home from school at certain time and route) that is tracked by the user's device. Likewise, the content of the questions is location based. For example, a student walks into a math class 5 minutes before class starts and he would like to text. The gateway would be math themed questions of the day sponsored by the teacher of math questions customized to the student's current trends on tests and quizzes. And in a commercial setting, a customer at Starbucks® store or website might be asked a series of questions about the nutritional value of his most recent purchases. Further still, in an employment setting the employee may be asked a series of questions about laboratory safety or emergency exits as they move from one plant to another.

### GPS-based Trigger for Locking and Unlocking Mechanism

The reward may be initiated by the global positioning service (GPS) of the electronic device and the relative location of the student using the electronic device. For example, in one case the student could be walking home from school and passing by a Starbucks. At such time, as he falls with a specific boundary of the GPS coordinates relative to the Starbucks a reward potential could be activated to induce the student to learn in exchange for an immediate reward upon completing a particular learning assignment. As a simple example, the student could complete a module on his SAT prep at the Starbucks and receive an immediate reward.

In another case, a random reward could be location based where for example if a student was walking by a retail sponsor they could be informed of a particular reward. In the location based award a set of GPS coordinates would be activated such that any electronic device traveling within such GPS coordinates triggers a reward such as drop into WalMart® store for a discount or a free soda.

### GPS-based Check-ins for Locking and Unlocking Mechanism

In another example of the invention, a third-party might require the device user on certain days of the week to (1) show up and check in to a specific location such as a school location by a certain time, (2) check in as still at school at the same location end of the school day, (3) check in at home by a certain time, (4) check in at home later in the evening to prove the user is still there. Rewards rules can be specified such as all four rules must be met for five days in a row to trigger a full allowance, or that for each check-in, $2 is accumulated into the allowance credits, or indeed, any number of other rules for rewards as described elsewhere. Each “check in session” could include specific unique learning questions or instructions that are customized to the end user to further confirm that the end user and the end user's device are in the specified coordinates requested by the third party.

### Electronic Device Usage/Credit Provided by Network Provider or Sponsor

In one scenario the student is provided a credit or full payment for their monthly service bill from their cell phone and/or cable carrier. The services that would be included would include all communications such as radio communications and satellite communications along with 2G to 4G Wi-Fi, cable and combinations as well. In a further example, the student is provided an electronic device and each day he earns time to access the features on the device in exchange for achieving targeted learning objectives. In a specific example, an at-risk child could be provided an electronic device and each incremental period such as a 24 hour period, a specific amount of learning content such as that related to the GED (general education diploma) would require a level of mastery in exchange for using the device for the incremental period. Further still, the results could be reported to third-party such as a sponsor or teacher or both.

### Anti-cheating Mechanism

An electronic device could be programmed with a motion detection sensor such that the user has to keep both hands on the phone. In one case he would have his left hand under the phone and his right hand held against the home screen while he calculates the answer in his head. In other words, an intent of the anti-cheating is to prevent the user from going to another device, such as a calculator or a friends smart device to solicit the answer. If an unauthorized motion is detected then a new instruction or question could be generated. In another instance of anti-cheating mechanisms an optical tracking software such as the programs created by Tobii Technology, Inc. or the eye tracking software from Samsung Group in their Android 4.2 version. Using optical tracking if the user takes his eye off or away from the screen for a preset time such as 3 seconds then another instruction or question would be created for example.

In each case of an expected act of cheating, the result could be an immediate suspension of use, limited accessibility, reduced time, time subtracted, etc. These are only a few examples of how one familiar with the art of teaching and electronic device detection features would include in an anti-cheating mechanism.

### Compulsion Loop

Researchers and scientists are frequently publishing reports that refer to the new levels of addiction to electronic entertainment. For example, one study of more than 1,000 students from 10 countries and 12 universities concluded that the majority were not able to voluntarily forego their electronic connections for a mere 24 hours. In particular, the study found that these college students admitted to being “addicted” to modern technology such as mobile phones, laptops and television as well as social networking applications offered by Facebook, Inc. and Twitter, Inc.

Functional magnetic resonance imaging (fMRI) was used, in another study, to visualize which parts of the brain were engaged during certain aspects of social media. The overall conclusions were that the use of social media, and in particular expressing one's owns opinion, positively triggers dopamine reward pathways. The researchers even determined that many of the subjects would prefer reporting their own experiences to receiving a monetary reward.

Similar indications were noted in certain video gaming, which introduce high levels of “randomness” in reward granting as an intentional means of forming an addiction. The idea dates back decades and its used to create a compulsion loop that keeps the player engaging in the activity. The technique is referred to as the variable ratio of reinforcement (or operant conditioning). It is considered simple and powerful and is believed to be one of the reasons gambling is so addictive. This trend of operant conditioning has also led to a number of allegations that emailing possesses addictive characteristics. In fact, a new term of “emailoholics” emerged as the result of one author's studies. In this regard, using a random nature of rewards would entice the end users or students to engage in the invention. Further, having a system that enables a range of different reward types and levels is a targeted objective of this invention as well.

### Captive Marketing and Advertising

While the user is locked out of his phone (or electronic device) or participating in a contest while trying access to his phone, advertisers including the retailers have a captive audience for a host of different advertising options to those familiar with the art of on-line advertising and marketing on the world wide web. In one instance, the advertiser could use a retailers name in the form of the various questions, such as if one mocha from a Retailer costs $2.00 and a customer purchases five mochas, how much will the customer spend is an example of a question. Alternatively, if the Retailer's rewards card has $50.00 credit and a customer spends $17.50 what is the balance on the rewards card is another example of a question. Alternatively, banner adds could be placed or other features such as the mathematics content is brought to you a particular Retailer.

A critical feature of the locking mechanisms is the creation of a unique opportunity for targeted marketing that is used directly or indirectly with education, instruction or contest material. In such a case, advertisers would compensate the hosting cloud (or network) who is coordinating the introduction of the marketing material into the education content directly (or any parties working indirectly together or in combinations) as part of the question or as a separate advertisement. In yet another embodiment of the invention the separate advertisement may be accessible directly or only after another question or series of questions is generated on the display of the electronic device. Further still, the advertisers could rely on the nature of the content of the questions for the demographics of the targeted end user providing both a captive audience in combination with a demographically focused end user or group of end users. This example of a system and method of captive marketing and advertising is not limited to only these examples rather it is illustrative of one aspect of the current invention. The captive marketing mechanism could be integrated into each of the examples and illustrations included herein by one familiar with the relevant art.

In such a case, advertisers would compensate a hosting software who is coordinating the introduction of the marketing material into the education content directly as part of the question or as a separate advertisement. In yet another embodiment of the invention the separate advertisement may be accessible directly or only after another question or series of questions is generated. Further still, the advertisers could rely on the nature of the content of the questions for the demographic of the targeted user providing both a captive audience along with a demographically focused. This discussion of captive marketing in not limited to these examples rather its is illustrative of one aspect of the current invention.

The reward feature may be further exemplified and enhanced by the type of reward trigger, the reward types, the rewards redemption, reward gamesmanship, and reward providers. Below are specific examples of each and demonstrate the various types of individual activities that one familiar with the art could incorporate.

Rewards Triggers include: check-in at certain places such as school, third-party school reporting, extracurricular conditions/goals, completion of chores, school attendance, homework completion, direct teacher third party reporting, API to teacher server for tracking grades, API to school hosting server, accomplishing specified blocks of educational content, exposure to certain blocks/time periods of learning content (video, audio, ebook), incentives for study groups/studying content together with device users, group contests, educational content, extracurriculars—outside contests that specify device user(s) as meeting, criteria, and allot those rewards to qualifying user id's for redemption

Rewards Types include: Cumulative allowance credit, activated in portions for continued performance of criteria rules, Periodic allowance credit activated periodically for fulfilling minimum conditions, Third Party bestowal and third party can immediately bestow through portal for arbitrary things (mowing lawn, polite behavior, etc.)

Rewards Redemption include: partnership with Square, Inc. and/or other mobile payment apps/companies, partnership with credit card company—puts money right on a debit card credits stored as data which work toward participating partner programs, partnerships with vendors/sponsors, and programs/contests at school or other third parties

Rewards Gamesmanship include: students can double down (or specified extra reward) with rewards by completing extra credit education content, students can risk losing x and stand to gain y, by attempting harder extra credit, question(s) which proved an A+ level of excellence in learning the material, a special Third Party at any “real life” gamesmanship can be designated to be, the “decider” of an award or contest, for example, for a sprint, or a talent, show, and immediately bestow the award to the user via their user id to a portal or directly using his device and the user's device through application on each device using NFC or QR code or what not.

Rewards Providers include: Vendors, Schools/institutions and Third Party (parent)—selects a goal such as bicycle, wherein transaction using THEIR credit card gets unlocked by meeting rewards triggers/criteria. One familiar with the art would understand how these can be incorporated into the various reward features illustrated elsewhere in this document.

### Toys and Other Devices

The features discussed in various embodiments may also be used in conjunction with existing interactive toys and robots. For standalone toys and robots, and other electronic computing devices that are not connected to a network, the educational software is installed on the device, toy, or robot and coded to be compatible with the specific device and any other computer software associated with it. As a result, the user would have to successfully execute the testing modules of the present invention in order to gain access to the device, toy, or robot. And for interactive toys, robots, and other electronic computing devices connected to a network, the Educational software is downloaded to the device, toy, or robot, or accessible via the Question & Answer (Q & A) system server; and is coded to be compatible with the specific device, toy, or robot and any other software associated with it (e.g. toy mobile app). In other instances the interactive toys can be turned off by failing to complete the targeted objectives or the interactive toys level of interaction can be based on the advancement of the learning modules within the framework of this invention.

The features discussed in various embodiments can be integrated into these “smart” features in the car and will thusly disable the features in the car directly through the target electronic devices or into the separate software of the vehicle using API or other means well known to those in the art.

Combinations of electronic devices and smart device maybe incorporated into an embodiment of this invention whereby a variety of individual devices are used to achieve the learning objective. For example, smart glasses, a smart watch used in combination with a smart phone and a game console could be used to optimize the features of the sound section, anti-cheating and optical scanning features, among other items.

FIG. 15 contains a high-level block diagram showing an example architecture of a computer, which may represent any electronic device, any server, or any node within a cloud service as described herein. The computer 1500 includes one or more processors 1510 and memory 1520 coupled to an interconnect 1530. The interconnect 1530 shown in FIG. 15 is an abstraction that represents any one or more separate physical buses, point to point connections, or both connected by appropriate bridges, adapters, or controllers. The interconnect 1530, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1594 bus, also called “Firewire”.

The processor(s) 1510 is/are the central processing unit (CPU) of the computer 1500 and, thus, control the overall operation of the computer 1500. In certain embodiments, the processor(s) 1510 accomplishes this by executing software or firmware stored in memory 1520. The processor(s) 1510 may be, or may include, one or more programmable general-purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or the like, or a combination of such devices.

The memory 1520 is or includes the main memory of the computer 1500. The memory 1520 represents any form of random access memory (RAM), read-only memory (ROM), flash memory, or the like, or a combination of such devices. In use, the memory 1520 may contain code 1570, containing instructions according to the techniques disclosed herein.

Also connected to the processor(s) 1510, through the interconnect 1530 are a network adapter 1540 and a storage adapter 1550. The network adapter 1540 provides the computer 1500 with the ability to communicate with remote devices over a network and may be, for example, an Ethernet adapter or Fibre Channel adapter. The network adapter 1540 may also provide the computer 1500 with the ability to communicate with other computers. The storage adapter 1550 allows the computer 1500 to access a persistent storage, and may be, for example, a Fibre Channel adapter or SCSI adapter.

The code 1570 stored in memory 1520 may be implemented as software and/or firmware to program the processor(s) 1510 to carry out actions described above. In certain embodiments, such software or firmware may be initially provided to the computer 1500 by downloading it from a remote system through the computer 1500 (e.g., via network adapter 1540).

### CONCLUSION

The techniques introduced herein can be implemented by, for example, programmable circuitry (e.g., one or more microprocessors) programmed with software and/or firmware, or entirely in special-purpose hardwired circuitry, or in a combination of such forms. Software or firmware for use in implementing the techniques introduced here may be stored on a machine-readable storage medium and may be executed by one or more general-purpose or special-purpose programmable microprocessors.

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

The various embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

What is claimed is:

1. A method of creating a customized reward-based improvement experience for a user, comprising:
determining a learning state related to a reward for the user from one or more learning states;
determining a learning activity status related to the reward for the user from one or more learning activity statuses;
determining a reward category related to the reward for the user from one or more reward categories; and
granting a reward to the user based on the determined learning state, the determined learning activity status, and the determined reward category.

2. The method of claim 1, wherein
the one or more learning states include achieving a preset milestone, demonstrating an effort, or performing a learning activity, and
the learning state is determined based on a level of learning motivation produced by granting the reward at a learning state.

3. The method of claim 1, wherein
the one or more learning activity statuses include before performing a learning activity, at a beginning of the learning activity, during the learning activity, at an end of the learning activity, or following the learning activity, and
the learning activity status is determined based on a level of learning motivation produced by granting the reward at a learning activity status.

4. The method of claim 1, wherein
the one or more reward categories include an authorization of access of functions of a device of the user, a credit to make a purchase online, a credit to make a purchase at retail, a deposit to a bank account, a coupon for an item, or a designation of improvement progress on social media, and
the reward category is determined based on a level of learning motivation produced by granting the reward in a reward category.

5. The method of claim 1, wherein the determinations are based on one or more of an assessment of the user, an analysis of the user's past reward-based improvement experiences, and an analysis of the user's current reward-based improvement experiences.

6. The method of claim 1, wherein granting a reward to the user includes granting a reward in the determined reward category when the user reaches the determined learning state and the determined learning activity status.

7. The method of claim 2, wherein when the learning state is performing a learning activity, granting a reward to the user is further based on one or more of a physical location of the user, personal information of the user, or a nature of the learning activity.

8. The method of claim 4, wherein the device of the user is a tablet, a smartphone, a personal digital assistant, a laptop, a desktop computer, a television, or a gaming station.

9. A system for creating a customized reward-based improvement experience for a user, comprising:
a first determination unit configured to determine a learning state for providing the user with a desirable level of learning motivation, wherein the learning state indicates whether the user is learning, making progress in learning, or achieving a milestone in learning;
a second determination unit configured to determine a learning activity status for providing the user with a desirable level of learning motivation, wherein the learning activity status indicates where the user stands with respect to a course of a learning activity;
a third determination unit configured to determine a reward category for providing the user with a desirable level of learning motivation; and
a customization unit configured to grant a reward to the user based on the determined learning state, the determined learning activity status, and the determined reward category.

10. The system of claim 9, further comprising a reward unit configured to communicate with a reward system regarding the reward to be granted to the user.

11. The system of claim 9, further comprising an education unit configured to communicate with an education system regarding the learning activity performed by the user.

12. The system of claim 9, wherein the learning activity is performed on a mobile electronic device of the user, and the reward is delivered to the mobile electronic device.

13. The system of claim 9, further comprising
a detecting unit configured to detect a current learning state and a current learning activity status of the user,
wherein the customization unit grants a reward in the determined reward category when the detected learning state is equal to the determined learning state and the detected learning activity status is equal to the determined learning activity status.

14. A non-transitory machine-readable storage medium having stored thereon a set of instructions which when executed causes a computer to perform a method of managing customized reward-based improvement experiences for a user, the method comprising:
detecting a current learning state and a current learning activity status of the user,
wherein the learning state indicates whether the user is learning, making progress in learning, or achieving a milestone in learning, and the learning activity status indicates where the user stands with respect to a course of a learning activity,
determining whether the detected learning state is equal to a predetermined learning state and whether the detected learning activity status is equal to a predetermined learning activity status; and
when the determination result is positive, granting a reward in a predetermined reward category to the user.

15. The non-transitory machine-readable storage medium of claim 14, wherein the method further comprises updating the predetermined learning state or the predetermined learning activity status when the user rejects the granted reward, request a reward different from the granted reward, or requests a reward when no reward is being granted.
